(19) United States
(12) Patent Application Publication
(10) Pub. No.: US 2026/0161720 A1
(43) Pub. Date: Jun. 11, 2026

(54) AI ASSISTED VIDEO GAME TUTORIAL FINDER AND CONTENT CREATOR

(71) Applicant: Google LLC, Mountain View, CA (US)

(72) Inventors: Christopher James Tegethoff, Portland, OR (US); Amith Tudur Raghavendra, Newark, CA (US)

(21) Appl. No.: 19/413,781

(22) Filed: Dec. 9, 2025

Related U.S. Application Data
(60) Provisional application No. 63/730,901, filed on Dec. 11, 2024.

(51) Int. Cl. G06F 16/9535; A63F 13/67; G06F 16/2457; G06F 16/9538

(52) U.S. Cl. CPC G06F 16/9535; A63F 13/67; G06F 16/24578; G06F 16/9538

(57) ABSTRACT

An example computing system receives input associated with content (e.g., a video game) being presented in an active play mode, and performs a search for other content (e.g., tutorial videos) associated with the content. In examples in which the input indicates a user wants to create new content for underrepresented areas of play, the computing system may transition, based on a level of representation for the content in the active play mode in the other content, the active play mode to a content creation mode, in which the computing system creates new content on behalf of the user. In examples in which the input indicates the user has difficulty advancing past their current progress point, the computing system may transition the active play mode to a content finder mode instead of the content creation mode, in which the computing system finds and presents the other content to the user.

### CROSS REFERENCE TO RELATED APPLICATION

This application claims the benefit of U.S. Provisional Ser. No. 63/730,901 filed Dec. 11, 2024, which is incorporated by reference herein in its entirety.

### BACKGROUND

Video games are a popular pastime that attracts players from various age groups, skill levels, and backgrounds. As gaming continues to mature and diversify, games have become increasingly complex, featuring expansive worlds, intricate puzzles, and tough battles that can challenge even the most experienced players. While this depth adds to the appeal of video games, gamers may often find themselves stuck at pivotal moments, and may search for tutorials to move forward. With the sheer number of games and the unique challenges they present, manually finding the right tutorial or walkthrough video can be tedious and disrupt the flow of gameplay. Furthermore, the right tutorials may not even exist.

### SUMMARY

In general, aspects of this disclosure are directed to techniques for intelligently finding or generating content based on input received while a user is in an active play mode. For example, an example computing system may receive at least one input associated with content (e.g., a video game) being presented in the active play mode, e.g., the user may be currently streaming or playing the video game. In some examples, the at least one input may be an indication of a request or inquiry provided by the user, an indication of a determined request, etc. As an example, while playing the video game, the user may reach a level, progress point, etc. in the video game in which the user wants to find and/or create content associated with the video game at that level or progress point (e.g., a tutorial for the video game). As such, the computing system may receive at least one input associated with the video game that the user is currently playing, and may perform, using a machine learning model, a search for content that is associated with at least a portion of the video game (e.g., a level in the video game). For example, the computing system may search a video platform, database, web browser, etc., to find other content that relates to the portion of the video game, such as tutorial videos. In some examples, the computing system may use machine learning techniques to determine similarity scores between the portion of the video game and the other content found. In some examples, such as examples in which a user requests a tutorial for help, the computing system may transition the active play mode to a content finder mode, in which the computing system may generate instructions to display the other content to the user. In some examples, such as examples in which a user wants to create content based on underrepresented gameplay areas and search trends, the computing system may determine a level of representation for the portion of the video game in the other content. That is, the computing system may determine, for example, a number of tutorial videos for the video game at the user's current level or progress point that already exist. In some examples, responsive to the computing system determining the level of representation to be below a threshold level of representation, the computing system may transition the active play mode to a content creation mode, e.g., to automatically create content for the user. In some examples, transitioning to the content creation mode may involve retrieving captured content, e.g., content in the active play mode may be captured and saved, at least temporarily, and once the computing system transitions to the content creation mode, at least a portion of this captured content may be used for content creation and/or later publishing.

In one example, the disclosure is directed toward a method that includes receiving, by a computing system, at least one input associated with content being presented in an active play mode, and responsive to receiving the at least one input, performing, by the computing system, and using a machine learning model, a search for other content that is associated with at least a portion of the content being presented in the active play mode. The method further includes determining, by the computing system and based on the search, a level of representation for at least the portion of the content in the other content, and responsive to determining the level of representation does not satisfy a threshold level of representation, transitioning, by the computing system, the active play mode to a content creation mode.

In another example, the disclosure is directed toward a computing system comprising one or more processors, and one or more storage devices that store instructions. The instructions, when executed by the one or more processors, cause the one or more processors to receive at least one input associated with content being presented in an active play mode, and responsive to receiving the at least one input, perform, using a machine learning model, a search for other content that is associated with at least a portion of the content being presented in the active play mode. The instructions further cause the one or more processors to determine, based on the search, a level of representation for at least the portion of the content in the other content, and responsive to determining the level of representation does not satisfy a threshold level of representation, transition the active play mode to a content creation mode.

In another example, the disclosure is directed toward a non-transitory computer-readable storage medium encoded with instructions that, when executed by one or more processors, cause one or more processors to receive at least one input associated with content being presented in an active play mode, and responsive to receiving the at least one input, perform, using a machine learning model, a search for other content that is associated with at least a portion of the content being presented in the active play mode. The instructions further cause the one or more processors to determine, based on the search, a level of representation for at least the portion of the content in the other content, and responsive to determining the level of representation does not satisfy a threshold level of representation, transition the active play mode to a content creation mode.

In another example, the disclosure is directed toward a computer program product for intelligently finding content. The computer program product comprises instructions that, when executed by one or more processors, cause the one or more processors to receive at least one input associated with content being presented in an active play mode, and responsive to receiving the at least one input, perform, using a machine learning model, a search for other content that is associated with at least a portion of the content being presented in the active play mode. The instructions further cause the one or more processors to determine, based on the search, a level of representation for at least the portion of the content in the other content, and responsive to determining the level of representation does not satisfy a threshold level of representation, transition the active play mode to a content creation mode.

In another example, a method includes receiving, by a computing system, at least one natural language query associated with content being presented in a first portion of an active play mode user interface, and outputting, by the computing system, and for display, text data indicative of the at least one natural language query in a second portion of the active play mode user interface. The method further includes applying, by the computing system, a machine learning model to the at least one natural language query to generate at least one natural language response for the at least one natural language query, and outputting, by the computing system, and for display, the at least one natural language response in the second portion of the active play mode user interface.

The details of one or more examples of the disclosure are set forth in the accompanying drawings and the description below. Other features, objects, and advantages of the disclosure will be apparent from the description and drawings, and from the claims.

### BRIEF DESCRIPTION OF THE FIGURES

FIG. 1 is a conceptual diagram illustrating an example computing system for intelligently finding or generating content based on input received while a user is in an active play mode, in accordance with one or more techniques of this disclosure.

FIG. 2 is a block diagram illustrating another example computing system for intelligently finding or generating content based on input received while a user is in an active play mode, in accordance with one or more techniques of this disclosure.

FIG. 3A is a conceptual diagram illustrating an example training process for a machine learning module, in accordance with one or more techniques of this disclosure.

FIG. 3B is a conceptual diagram illustrating an example trained machine learning module, in accordance with one or more techniques of this disclosure.

FIG. 3C is a conceptual diagram illustrating a machine learning module configured to find and analyze content based on input received while a user is in an active play mode, in accordance with one or more techniques of this disclosure.

FIG. 4 is a conceptual diagram illustrating an example of a content creation mode, in accordance with one or more techniques of this disclosure.

FIG. 5 is a conceptual diagram illustrating an example of a content finder mode, in accordance with one or more techniques of this disclosure.

FIG. 6 is a conceptual diagram illustrating another example of an active play mode, in accordance with one or more techniques of this disclosure.

FIG. 7 is a flowchart illustrating an example operation for intelligently finding or generating content based on input received while a user is in an active play mode, in accordance with one or more techniques of this disclosure.

FIG. 8 is a flowchart illustrating an example operation for displaying generated output based on input received while a user is in an active play mode, in accordance with one or more techniques of this disclosure.

### DETAILED DESCRIPTION

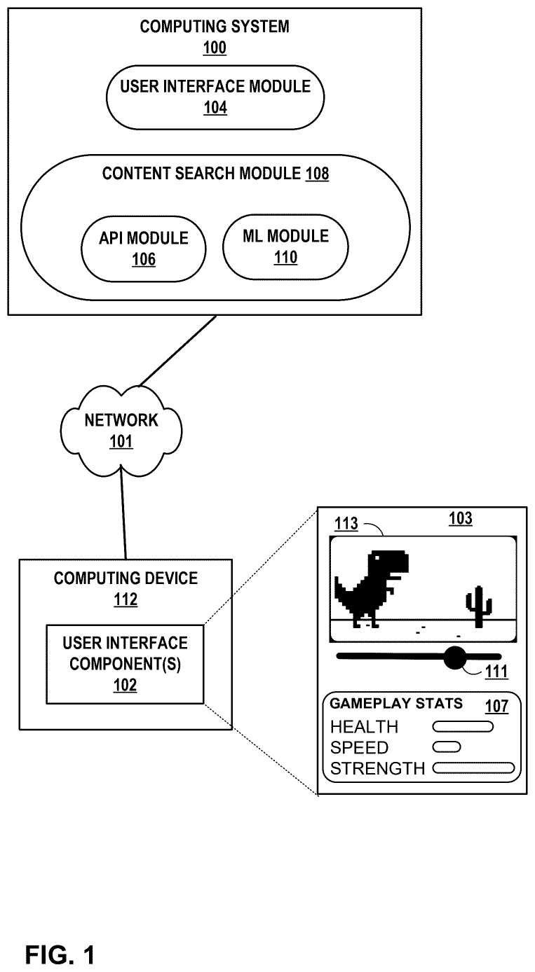

FIG. 1 is a conceptual diagram illustrating an example computing system for intelligently finding or generating content based on input received while a user is in an active play mode, in accordance with one or more techniques of this disclosure. In the example of FIG. 1, a user may interact with computing device 112 that is in communication with computing system 100. In some examples, some or all of the components and/or functionality attributed to computing system 100 may be implemented or performed by computing device 112.

In some examples, computing system 100 may be implemented on a plurality of computing devices that may include, but are not limited to, portable, mobile, or other devices, such as mobile phones (including smartphones), laptop computers, desktop computers, tablet computers, smart television platforms, server computers, mainframes, etc. In some examples, computing system 100 may represent a cloud computing system that provides one or more services via network 101. That is, in some examples, computing system 100 may be a distributed computing system.

In examples in which computing system 100 may be a distributed system, such as in the example of FIG. 1, computing system 100 may communicate with computing device 112 via network 101. Network 101 may include any public or private communication network, such as a cellular network, Wi-Fi network, a direct cell-to-satellite communication network, or other type of network for transmitting data between computing system 100 and computing device 112. In some examples, network 101 may represent one or more packet switched networks, such as the Internet. Computing device 112 may send and receive data to and from computing system 100 across network 101 using any suitable communication techniques. For example, computing system 100 and computing device 112 may each be operatively coupled to network 101 using respective network links. Network 101 may include network hubs, network switches, network routers, etc., that are operatively inter-coupled thereby providing for the exchange of information between computing device 112 and computing system 100. In some examples, network links of network 101 may be Ethernet, ATM or other network connections. Such connections may include wireless and/or wired connections.

As shown in the example of FIG. 1, computing device 112 includes one or more user interface (UI) components (“UI components 102”). UI components 102 of computing device 112 may be configured to function as input devices and/or output devices for computing device 112. UI components 102 may be implemented using various technologies. For instance, UI components 102 may be configured to receive input from a user through tactile, audio, and/or video feedback. Examples of input devices include a presence-sensitive display, a presence-sensitive or touch-sensitive input device (such as that shown in FIG. 1), a mouse, a keyboard, a voice responsive system, video camera, microphone or any other type of device for detecting a command from a user. In some examples, a presence-sensitive display includes a touch-sensitive or presence-sensitive input screen, such as a resistive touchscreen, a surface acoustic wave touchscreen, a capacitive touchscreen, a projective capacitive touchscreen, a pressure sensitive screen, an acoustic pulse recognition touch screen, or another presence-sensitive technology. That is, UI components 102 of computing device 112 may include a presence-sensitive device that may receive tactile input from a user. UI components 102 may receive indications of the tactile input by detecting one or more gestures from a user (e.g., when a user touches or points to one or more locations of UI components 102 with a finger or a stylus pen).

UI components 102 may additionally or alternatively be configured to function as an output device by providing output to a user using tactile, audio, or video stimuli. Examples of output devices include a sound card, a video graphics adapter card, or any of one or more display devices, such as a liquid crystal display (LCD), dot matrix display, light emitting diode (LED) display, microLED, miniLED, organic light-emitting diode (OLED) display, e-ink, or similar monochrome or color display capable of outputting visible information to a user. Additional examples of an output device include a speaker, a haptic device, or other device that can generate intelligible output to a user. For instance, UI components 102 may present output to a user as a graphical user interface that may be associated with functionality provided by computing device 112. In this way, UI components 102 may present various user interfaces of applications executing at or accessible by computing device 112 (e.g., a gaming application, a platform that hosts various types of media or content, etc.). A user may interact with a respective user interface to cause computing device 112 to perform operations relating to a function provided by the application.

In some examples, UI components 102 of computing device 112 may detect two-dimensional and/or three-dimensional gestures as input from a user. For instance, a sensor of UI components 102 may detect the user's movement (e.g., moving a hand, an arm, a pen, a stylus, etc.) within a threshold distance of the sensor of UI components 102. UI components 102 may determine a two-or three-dimensional vector representation of the movement and correlate the vector representation to a gesture input (e.g., a hand-wave, a pinch, a clap, a pen stroke, etc.) that has multiple dimensions. In other words, UI components 102 may, in some examples, detect a multidimensional gesture without requiring the user to gesture at or near a screen or surface at which UI components 102 output information for display. Instead, UI components 102 may detect a multi-dimensional gesture performed at or near a sensor which may or may not be located near the screen or surface at which UI components 102 output information for display.

In the example of FIG. 1, computing system 100 includes user interface (UI) module 104. UI module 104 may perform operations described herein using hardware, software, firmware, or a mixture thereof residing in and/or executing at computing system 100. Computing system 100 may execute UI module 104 with one processor or with multiple processors. In some examples, computing system 100 may execute UI module 104 as a virtual machine executing on underlying hardware. UI module 104 may execute as one or more services of an operating system or computing platform or may execute as one or more executable programs at an application layer of a computing platform.

UI module 104, as shown in the example of FIG. 1, may be operable by computing system 100 to perform one or more functions, such as receive input and send indications of such input to other components associated with computing system 100. UI module 104 may also receive data from components associated with computing system 100. Using the data received, UI module 104 may cause other components associated with computing system 100, such as UI components 102, to provide output based on the data. For instance, UI module 104 may send data to UI components 102 of computing device 112 to display a graphical user interface (GUI), such as GUI 103.

In general, a user may be provided with an opportunity to provide input to control whether programs or features of computing device 112 and/or computing system 100 can collect and make use of user information (e.g., a user's personal data, information about a user's current location, location history, activity, etc.), or to dictate whether and/or how computing device 112 and/or computing system 100 may receive content that may be relevant to a user, such as user information retrieved from one or more applications installed at computing device 112. Other user information may include data that includes the context of user usage, either obtained from an application itself or from other sources. Examples of usage context may include breadth of share (sharing publicly, or with a large group, or privately, or a specific person), context of share, etc. When permitted by the user, additional data can include the state of the device, e.g., the location of the device, the apps running on the device, etc. In addition, certain data may be treated in one or more ways before it is stored or used by computing device 112 and/or computing system 100 so that personally identifiable information is removed. For example, a user's identity may be treated so that no personally identifiable information can be determined about the user, or a user's geographic location may be generalized where location information is obtained (such as to a city, ZIP code, or state level), so that a particular location of a user cannot be determined. Thus, a user may have control over how information is collected about them and used by computing device 112 and/or computing system 100. For example, a user may be prompted by computing device 112 to provide explicit consent for computing device 112 and/or computing system 100 to retrieve and/or store any or all of a user's data, including input associated with content being presented in an active play mode to the user. In some examples, an action log executed on computing device 112 may provide a user a ledger of activity, which may show any automations or applications running in the background of computing device 112, as well as an accurate log of all content search and/or creation activity.

In the example of FIG. 1, GUI 103 may be an example representation of a user's current screen while streaming or playing content, such as a video game. That is, GUI 103 may be an example GUI for a gaming application. As shown in the example of FIG. 1, GUI 103 may present content 113 in an active play mode. The “active play mode” may be considered a gameplay mode, or a mode in which a user is actively engaging in the displayed content. In general, GUI 103 may be considered an active play mode user interface. As shown in the example of FIG. 1, GUI 103 may include other UI elements, such as a “GAMEPLAY” text header and “Gameplay Stats” viewer 107, which may be an example UI element for the gaming application that displays the user's gameplay statistics (e.g., “Health,” “Speed,” “Strength,” etc.) while the user is actively playing the video game. In some examples, GUI 103 may include an indication of the user's current progress point in the content, e.g., progress point 111. That is, in the example of FIG. 1, progress point 111 may indicate a level that the user is currently playing in the video game, a percentage of the video game that the user has completed, a timestamp, etc. In general, GUI 103 may represent one example of a GUI for presenting content in an active play mode. GUI 103 may include additional elements not shown in FIG. 1, or may include elements that are different from those shown in FIG. 1.

In general, while playing content, such as a video game, a user may reach a level, progress point, etc. in the video game in which the user wants to find and/or create content associated with the video game at that level or progress point (e.g., a tutorial for the video game). For example, in some examples, a user may reach progress point 111 and determine that they need help (e.g., a tutorial video) to further advance their progress in the video game. However, manually finding the right tutorial or walkthrough video can be tedious and disrupt the flow of gameplay, e.g., the user may have to exit the current gaming application to search for relevant tutorials. In some other examples, though, a user may be a content creator and may wish to create content for the video game (e.g., create a tutorial for other users to use). In these examples, the user may prefer to create content based on underrepresented gameplay areas and search trends. For example, a user may inquire about creating content for progress point 111, which may represent a level in the video game. As such, in general, computing system 100 may receive at least one input associated with content 113 being presented in the active play mode (e.g., the video game that the user is currently playing). In some examples, the at least one input associated with content 113 being presented in the active play mode may include one or more of an indication of a request from a user (e.g., a request to find other content that helps the user advance past progress point 111, a request to analyze whether progress point 111 is a gameplay area that is underrepresented in other content, etc.), an indication of a determined request (e.g., a request that is determined by computing system 100 based on an activity log for content 113 being presented in the active play mode), an indication of progress point 111 in content 113 being presented in the active play mode (e.g., a timestamp, game level, etc.), context information associated with content 113 being presented in the active play mode (e.g., a title of the video game), and at least a portion of content 113 being presented in the active play mode (e.g., video clips, frames, etc. associated with progress point 111).

In general, responsive to receiving the at least one input associated with content 113 being presented in an active play mode, content search module 108 of computing system 100 may perform, using machine learning module 110, a search for other content that is associated with at least a portion of content 113. In some examples, responsive to receiving an indication of a request from a user, and with explicit consent from a user, content search module 108 may implement application programming interface (API) module 106 to retrieve additional information pertaining to content 113. That is, API module 106 may retrieve information associated with applications and/or platforms executing at computing device 112, such as a gaming application. In the example of FIG. 1, a gaming application that hosts content 113 may include an API that enables external applications or modules to interact with and use the data stored by the gaming application. As such, API module 106 may retrieve information associated with content 113, e.g., an API response. For example, API module 106 may retrieve an indication of progress point 111 in content 113 (e.g., a timestamp, game level, etc.), context information associated with content 113 (e.g., a title of the video game), at least a portion of content 113 (e.g., video clips, frames, etc. associated with progress point 111), etc. In general, API module 106, which can be considered an API library, may include multiple APIs that can be used to access one or more application APIs. In some examples, API module 106 may be configured to enable the exchanging of data in a standardized format. For example, API module 106 may support REST (Representational State Transfer), which is a widely used architectural style for building APIs that use HTTP (Hypertext Transfer Protocol) to exchange data between applications. In some examples, the information retrieved by API module 106 may be pre-processed by computing system 100. In some examples, the information retrieved by API module 106 may be in a data format that can be parsed by a machine learning model, such as a language model (e.g., the data may be in a structured or semi-structured data format).

In some examples, with explicit user consent, API module 106 may retrieve, continuously or periodically, context information associated with content 113 being presented in the active play mode and/or content 113 itself being presented in the active play mode. That is, in some examples, with explicit user consent, computing system 100 may continuously monitor a user's gameplay, such as to determine whether the user needs help advancing past a certain level or progress point. For example, in some examples, API module 106 may retrieve an activity log for at least a portion of content 113 being presented in the active play mode. In some examples, the activity log may include a length of time that a user has spent playing at progress point 111, the gameplay statistics displayed in “Gameplay Stats” viewer 107, and/or other information that may indicate a user is having difficulty in advancing through the video game. In some examples, machine learning module 110 may receive and analyze the activity log to determine whether a request should be generated on the user's behalf. That is, in some examples, computing system 100 may determine, based on the activity log, a request (e.g., a request that is intelligently determined using machine learning techniques) on behalf of the user. For example, machine learning module 110 may generate, based on the activity log, a request associated with content 113 being presented in the active play mode, in which the generated request (i.e., the request determined by machine learning module 110) may be provided to content search module 108 as input. As such, in some examples, the “determined request” may be considered a request that is determined automatically by computing system 100, e.g., computing system 100 may use one or more machine learning techniques, rule-based systems, etc. to determine a request on behalf of a user. In some examples, a “request” may be considered a prompt, a query, one or more instructions, and the like.

In accordance with techniques of this disclosure, computing system 100 may include a content search module 108 configured to intelligently find or generate content based on at least one input received while the user is in the active play mode. In general, with explicit consent from a user, content search module 108 may run continuously and be configured to monitor the content of an application (e.g., a gaming application) that hosts or displays content 113 and/or user activity pertaining to content 113. In some examples, with explicit consent from a user, content search module 108 may run continuously in the background of computing device 112. As such, API module 106 receives explicit consent from a user to gather information from a user and one or more applications installed at computing device 112 that may host and/or display content that a user may interact with. In general, content search module 108 may continuously retrieve and analyze information from computing device 112, again provided that a user has given explicit permission for computing system 100 to do so.

In general, content search module 108 may send information (e.g., any received and/or retrieved information) to machine learning module 110 only if computing system 100 receives permission from the user of computing device 112 to send the information. For example, in situations discussed in which computing system 100 and/or computing device 112 may collect, transmit, or may make use of personal information about a user (e.g., user account information, etc.), the user may be provided with an opportunity to control whether programs or features of computing system 100 can collect user information (e.g., information about a user's social network, a user's social actions or activities, a user's profession, a user's preferences, a user's current location, etc.), or to control whether and/or how computing system 100 and/or computing device 112 may store and share user information. Thus, the user may have control over how information is collected about the user and stored, transmitted, and/or used in accordance with techniques of this disclosure.

In general, with explicit consent from a user, content search module 108 may perform, using machine learning module 110, a search for other content that is associated with at least a portion of content 113 (e.g., associated with progress point 111, such as a specific level in the video game). For example, using the at least one input associated with content 113 being presented in the active play mode (e.g., a request to find other content that helps the user advance past progress point 111, a request to analyze whether progress point 111 is a gameplay area that is underrepresented in other content, a request that is determined or otherwise generated by machine learning module 110 that is based on an activity log for content 113, an indication of progress point 111 such as a timestamp or game level, context information associated with content 113 such as a title, and/or a portion of content 113 itself, such as video clips, frames, etc. associated with progress point 111), content search module 108 may search a video platform, database, web browser, etc., to find other content that relates to at least a portion of content 113, such as tutorial videos. In some examples, content search module 108 may use machine learning module 110, which may include a retrieval-augmented generation model, to perform the search. In some examples, machine learning module 110 may determine similarity scores between at least the portion of content 113 and the other content found via the search.

In some examples, such as examples in which a user requests a tutorial for help, computing system 100 may transition the active play mode to a content finder mode, in which content search module 108 may generate instructions to display the other content found via the search (e.g., tutorial videos) to the user. In some examples, such as examples in which a user wants to create content based on underrepresented gameplay areas and search trends, machine learning module 110 may determine a level of representation for the portion of content 113 in the other content. That is, machine learning module 110 may determine, for example, a number of tutorial videos for the video game at progress point 111 that already exist. In some examples, responsive to machine learning module 110 determining the level of representation to be below a threshold level of representation, computing system 100 may transition the active play mode to a content creation mode, e.g., to automatically create content for the user.

In general, with explicit user consent, computing device 112 may continuously capture content in an active play mode and/or computing system 100 may continuously receive the captured content. In general, with explicit user consent, computing device 112 and/or computing system 100 may store, at least temporarily (e.g., in a cache), the captured content. In some examples, content in an active play mode may be captured regardless of whether computing system 100 receives input to perform a search.

In some examples, transitioning to the content creation mode may involve retrieving the captured content, in which at least a portion of this captured content may be stored (e.g., in a persistent data store or database) for content creation and/or later publishing. For example, transitioning to the content creation mode may involve retrieving the captured content (e.g., the last 10, 20, 30, 40, 50, 60, 70, 80, 90, 100, 120, etc. seconds of the user's screen) from a rolling buffer, in which the retrieved captured content may then be used to create new content that the user can save and/or publish. In some other examples, transitioning to the content creation mode may involve starting a recording of the user's current screen, e.g., GUI 103, in which the recording may capture content 113 during the user's gameplay. Then, computing system 100 may stop the recording and receive the recorded video, which may be stored by content search module 108 for future use and/or publishing.

In this way, the techniques described herein may provide users the ability to quickly and easily find other content that is related to the content they are currently streaming or playing, in that users may not have to stop or pause their content and perform their own search. Furthermore, the techniques described herein may provide users the ability to quickly and easily generate content, as the example computing system may automatically create content for users on their behalf when the computing system intelligently determines that the content is underrepresented on various content platforms. Thus, the techniques described herein may improve user experience with content searches and content creation.

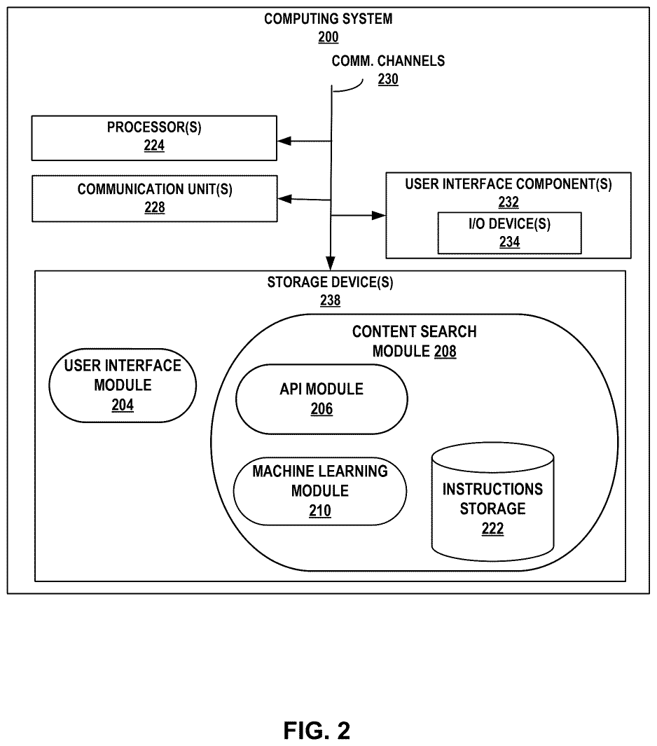

FIG. 2 is a block diagram illustrating another example computing system for intelligently finding or generating content based on input received while a user is in an active play mode, in accordance with one or more techniques of this disclosure. As shown in the example of FIG. 2, computing system 200 includes processors 224, one or more communication channels 230, one or more user interface components (UIC) 232, one or more communication units 228, and one or more storage devices 238. Storage devices 238 of computing system 200 may include user interface module 204, and content search module 208. As shown in the example of FIG. 2, content search module 208 further includes API module 206, machine learning module 210, and instructions storage 222.

Some or all of the components and/or functionality attributed to computing system 200 may be implemented or performed by a computing device that may be in communication with computing system 200. In other examples, computing system 200 may be considered a computing device, such as a user computing device (e.g., a mobile phone). Computing system 200, user interface module 204, content search module 208, API module 206, machine learning module 210, and user interface (UI) components 232 may be similar if not substantially similar to computing system 100, user interface module 104, content search module 108, API module 106, machine learning module 110, and user interface (UI) components 102 of FIG. 1, respectively.

The one or more communication units 228 of computing system 200, for example, may communicate with external devices by transmitting and/or receiving data at computing system 200, such as to and from remote computer systems or computing devices. Example communication units 228 include a network interface card (e.g., such as an Ethernet card), an optical transceiver, a radio frequency transceiver, or any other type of device that can send and/or receive information. Other examples of communication units 228 may be devices configured to transmit and receive Ultrawideband®, Bluetooth®, GPS, 3G, 4G, and Wi-Fi®, etc. that may be found in computing devices, such as mobile devices and the like.

As shown in the example of FIG. 2, communication channels 230 may interconnect each of the components as shown for inter-component communications (physically, communicatively, and/or operatively). In some examples, communication channels 230 may include a system bus, a network connection (e.g., to a wireless connection), one or more inter-process communication data structures, or any other components for communicating data between hardware and/or software locally or remotely.

One or more I/O devices 234 of computing system 200 may receive inputs and generate outputs. Examples of inputs are tactile, audio, kinetic, and optical input, to name only a few examples. Input devices of I/O devices 234, in one example, may include a touchscreen, a touchpad, a mouse, a keyboard, a voice responsive system, a video camera, buttons, a control pad, a microphone or any other type of device for detecting input from a human or machine. Output devices of I/O devices 234, may include, a sound card, a video graphics adapter card, a speaker, a display, or any other type of device for generating output to a human or machine.

User interface module 204, content search module 208, API module 206, machine learning module 210, and instructions storage 222 (hereinafter “modules 204-222”) may perform operations described herein using software, hardware, firmware, or a mixture of hardware, software, and firmware residing in and executing on computing system 200 or at one or more other computing devices (e.g., a cloud-based application-not shown). For example, some or all of modules 204-222 may be included in and executable on a local computing device, such as computing device 112 of FIG. 1. As such, the techniques described herein may all be implemented locally on a computing device.

Computing system 200 may execute one or more of modules 204-222, with one or more processors 224 or may execute any or part of one or more of modules 204-222 as or within a virtual machine executing on underlying hardware. One or more of modules 204-222 may be implemented in various ways, for example, as a downloadable or pre-installed application, remotely as a cloud application, or as part of the operating system of computing system 200. Other examples of computing system 200 that implement techniques of this disclosure may include additional components not shown in FIG. 2.

In the example of FIG. 2, one or more processors 224 may implement functionality and/or execute instructions within computing system 200. For example, one or more processors 224 may receive and execute instructions that provide the functionality of UIC 232, communication units 228, one or more storage devices 238 and an operating system to perform one or more operations as described herein. For example, one or more processors 224 may receive and execute instructions that provide the functionality of some or all of modules 204-222 to perform one or more operations and various functions described herein. The one or more processors 224 include a central processing unit (CPU). Examples of CPUs include, but are not limited to, a digital signal processor (DSP), a general-purpose microprocessor, a tensor processing unit (TPU); a neural processing unit (NPU); a neural processing engine; a core of a CPU, VPU, GPU, TPU, NPU or another processing device, an application specific integrated circuit (ASIC), a field programmable logic array (FPGA), or other equivalent integrated or discrete logic circuitry, or other equivalent integrated or discrete logic circuitry.

One or more storage devices 238 within computing system 200 may store information, such as information retrieved from a user computing device, or other data discussed herein, for processing during the operation of computing system 200. In some examples, one or more storage devices of storage devices 238 may be a volatile or temporary memory. Examples of volatile memories include random access memories (RAM), dynamic random-access memories (DRAM), static random-access memories (SRAM), and other forms of volatile memories known in the art. Storage devices 238, in some examples, may also include one or more computer-readable storage media. Storage devices 238 may be configured to store larger amounts of information for longer terms in non-volatile memory than volatile memory. Examples of non-volatile memories include magnetic hard disks, optical discs, floppy discs, flash memories, or forms of electrically programmable memories (EPROM) or electrically erasable and programmable (EEPROM) memories. Storage devices 238 may store program instructions and/or data associated with the modules 204-222 of FIG. 2.

In general, with explicit consent from a user, computing system 200 may retrieve, using API module 206, at least one input associated with content being presented in an active play mode. In some examples, the at least one input may include context information from an application, such as a gaming application that hosts and/or displays video game content. In some examples, the context information (retrieved with explicit user consent) may include, but is not limited to, application data, application usage data, application permissions, user data, user preference data, user feedback data, location data, system data, device data, network information, connectivity information, device battery data, sensor data, environmental data, time data, event data, notification data, and security data. The at least one input associated with content being presented in an active play mode may be referred to herein as “input data” that may be processed, stored, analyzed, transformed, etc. by computing system 200.

UI module 204 may receive information and instructions from one or more associated platforms, operating systems, applications, and/or services executing at the computing device (e.g., content search module 208) for generating one or more files each comprising a set of instructions. In some examples, a set of instructions may include instructions for generating a GUI, such as a content finder GUI and/or a content creation GUI, in which the GUI may display content found and/or generated by content search module 208. In some examples, UI module 204 may act as an intermediary between the one or more associated platforms, operating systems, applications, and/or services executing at the computing device and various output devices of the computing device (e.g., speakers, LED indicators, vibrators, etc.) to produce output (e.g., graphical, audible, tactile, etc.) with the computing device.

In some examples, content search module 208 may be implemented on a computing device in various ways. For example, content search module 208 may be implemented as a downloadable or pre-installed application or “app.” In another example, content search module 208 may be implemented as part of an operating system of a computing device.

Instructions storage 222 is a storage repository that may store, with explicit user consent, information received by computing system 200 and/or information retrieved by API module 206. In general, the information retrieved by API module 206 may include API response data. For example, the information may be retrieved from one or more applications, platforms, databases, etc., in which the information may include information associated with various content. For example, the information may be retrieved from a gaming application that is currently presenting content in an active play mode to a user.

For example, the gaming application may include an API that enables external applications or modules to interact with and use the data stored by the application. As such, API module 206 may retrieve data associated with a user's current gameplay, e.g., an API response. Information may be stored in instructions storage 222 for use by other modules of content search module 208, such as machine learning module 210. In some examples, instructions storage 222 may operate, at least in part, as a cache for instructions retrieved from a computing device (e.g., using one or more communication units 228) or other computing devices. In general, instructions storage 222 may be configured as a database, flat file, table, or other data structure stored within storage device 238. In some examples, instructions storage 222 is shared between various modules executing at computing system 200 (e.g., between one or more of modules 204-222 or other modules not shown in FIG. 2). In other examples, a different data repository is configured for a module executing at computing system 200 that requires a data repository. Each data repository may be configured and managed by different modules and may store data in a different manner. In some examples, computing system 200 may receive and store information, such as the context information, from a computing device over a specified period of time.

In general, machine learning module 210 may be configured to interpret input data (e.g., input data associated with content being presented in an active play mode) received or retrieved by computing system 200, so as to perform a search for other content that is relevant to the content being presented in the active play mode. The input data may be in various data formats that may or may not be readable to machine learning module 210 (e.g., a language model included in machine learning module 210). In some examples, the input data may be in data formats including, but not limited to, JavaScript Object Notation (JSON), eXtensible Markup Language (XML), Ain't Markup Language (YAML), INI files, plain text, Comma-Separated Values (CSV), Structured Query Language (SQL), and Non-Structured Query Language (NoSQL). In some examples, the input data may be in binary formats, database records, highly specialized formats, etc. that may not be immediately readable to machine learning module 210. In these examples, the context information may be converted, manipulated, transformed, etc. into a readable format, such as structured or semi-structured text, and/or metadata may be used to interpret the context information. For example, machine learning module 210 may convert any input or context information to XML, or other structured text types, such as, but not limited to, HTML, JSON, CSV, INI Files, etc. In this way, the input data received by content search module 208 can be provided to ML module 210 in a standardized and/or readable format. Furthermore, in some examples, machine learning module 210 may determine the type of information to include in the structured text representation. More specifically, machine learning module 210 may analyze various application functionality, capabilities, and attributes, and/or other information stored in instructions storage 222, such as content descriptions, roles, states, actions, and/or other relevant properties of user interface elements.

As such, in some examples, the input data may be preprocessed. Preprocessing techniques may include extracting one or more additional features from raw data. For example, feature extraction techniques may be applied to the input data to generate one or more new, additional features. In some examples, computing system 100 may generate, based on the input data, a prompt, and may perform, using machine learning module 110, the search for the other content based on the prompt.

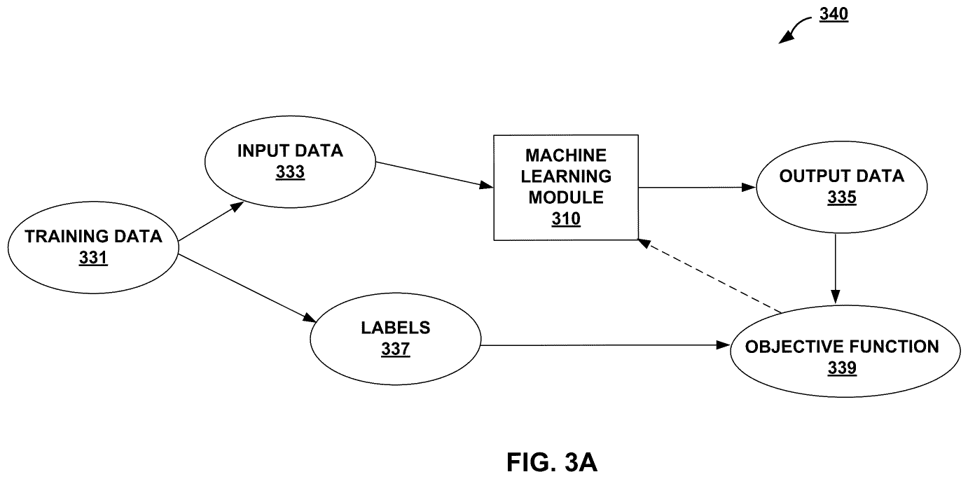

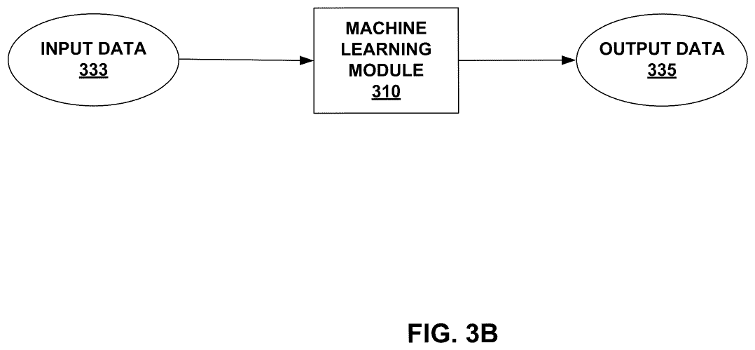

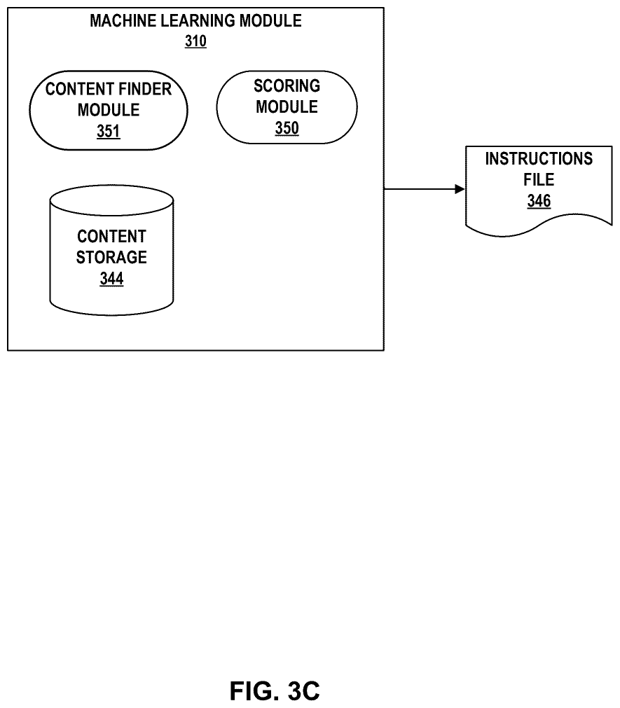

As such, in general, machine learning module 210 may employ a retrieval-augmented generation (RAG) model, a search-augmented model, or any other machine learning model that excels at natural language processing (NLP) and information retrieval capabilities. In some examples, machine learning module 210 may additionally or alternatively employ a language model, e.g., a large language model (LLM), a transformer-based language model, etc. that can process a prompt to understand its intent and extract relevant search queries. In some examples, machine learning module 210 may implement other machine-learned models that may be used in place of or in conjunction with a machine learning model that excels at natural language processing (NLP) and information retrieval capabilities, such as those described with respect to FIGS. 3A, 3B, and 3C. In some examples, machine learning module 210 may analyze portions of the retrieved information to interpret and understand other portions of the retrieved information.

The techniques of the present disclosure may be implemented by or otherwise executed on one or more computing devices (e.g., computing device 112 of FIG. 1). Examples of such computing devices include user computing devices (e.g., laptops, desktops, and mobile computing devices such as tablets, smartphones, wearable computing devices, etc.); embedded computing devices (e.g., devices embedded within a vehicle, camera, image sensor, industrial machine, satellite, gaming console or controller, or home appliance such as a refrigerator, thermostat, energy meter, home energy manager, smart home assistant, etc.); other computing devices; or combinations thereof. Computing system 200 and/or a computing device that implements machine learning module 210 or other aspects of the present disclosure may include a number of hardware components that enable the performance of the techniques described herein.

FIG. 3A is a conceptual diagram illustrating an example training process for a machine learning module, in accordance with one or more techniques of this disclosure. In some examples, computing device 112 of FIG. 1 may store and implement machine learning module 310 locally (i.e., on-device). Thus, in some examples, machine learning module 310 can be stored at and/or implemented locally by an embedded device or a user computing device such as a mobile device. Output data obtained through local implementation of machine learning module 310 at the embedded device or the user computing device can be used to improve performance of the embedded device or the user computing device (e.g., an application implemented by the embedded device or the user computing device). Machine learning module 310 described herein can be trained at a training computing system, and then provided for storage and/or implementation at one or more computing devices, such as computing device 112 of FIG. 1. In some examples, training process 340 executes locally at computing system 100 of FIG. 1. However, in some examples, training process 340 can be included in or separate from any computing system that implements machine learning module 310.

In general, machine learning module 310 may be or include one or more inference models, i.e., one or more trained machine learning models that can be used to make predictions based on new, unseen data. Machine learning module 310 may “infer” conclusions or outputs, which may be predictions, classifications, recommendations, or other types of decision-making. Machine learning module 310 may be trained according to one or more of various different training types or techniques. For example, in some examples, machine learning module 310 may be trained by training process 340 of FIG. 3A.

As further shown in the example of FIG. 3A, in some examples, machine learning module 310 may be trained on training data 331 that may include input data 333 that has labels 337. The training process shown in FIG. 3A is one example training process; other training processes may be used as well. In general, during training process 340, machine learning module 310 may learn patterns from training data 331, and training process 340 may optimize parameters for machine learning module 310 to minimize prediction errors.

Training data 331 can include, upon user permission for use of such data for training, anonymized usage logs of sharing flows, e.g., content items that were shared together, bundled content pieces already identified as belonging together, e.g., from entities in a knowledge graph, etc. In some examples, training data 331 can include examples of input data 333 that have been assigned labels 337 that correspond to output data 335.

In some examples, machine learning module 310 can be trained by optimizing an objective function, such as objective function 339. For example, in some examples, objective function 339 may be or include a loss function that compares (e.g., determines a difference between) output data generated by the model from the training data and labels (e.g., ground-truth labels) associated with the training data. For example, the loss function can evaluate a sum or mean of squared differences between output data 335 and the labels. In some examples, objective function 339 may be or include a cost function that describes a cost of a certain outcome or output data. Other examples of objective function 339 can include margin-based techniques such as, for example, triplet loss or maximum-margin training.

One or more of various optimization techniques can be performed to optimize objective function 339. For example, the optimization technique(s) can minimize or maximize objective function 339. Example optimization techniques include Hessian-based techniques and gradient-based techniques, such as, for example, coordinate descent; gradient descent (e.g., stochastic gradient descent); subgradient methods; etc. Other optimization techniques include black box optimization techniques and heuristics.

In some examples, backward propagation of errors can be used in conjunction with an optimization technique (e.g., gradient based techniques) to train machine learning module 310 (e.g., when a machine-learned model is a multi-layer model such as an artificial neural network). For example, an iterative cycle of propagation and model parameter (e.g., weights) update can be performed to train machine learning module 310. Example backpropagation techniques include truncated backpropagation through time, Levenberg-Marquardt backpropagation, etc.

In some examples, machine learning module 310 described herein can be trained using unsupervised learning techniques. Unsupervised learning can include inferring a function to describe hidden structure from unlabeled data. For example, a classification or categorization may not be included in the data. Unsupervised learning techniques can be used to produce machine-learned models capable of performing clustering, anomaly detection, learning latent variable models, or other tasks.

Machine learning module 310 can be trained using semi-supervised techniques which combine aspects of supervised learning and unsupervised learning. Machine learning module 310 can be trained or otherwise generated through evolutionary techniques or genetic algorithms. In some examples, machine learning module 310 described herein can be trained using reinforcement learning. In reinforcement learning, an agent (e.g., model) can take actions in an environment and learn to maximize rewards and/or minimize penalties that result from such actions. Reinforcement learning can differ from the supervised learning problem in that correct input/output pairs are not presented, nor sub-optimal actions explicitly corrected.

In some examples, one or more generalization techniques can be performed during training to improve the generalization of machine learning module 310. Generalization techniques can help reduce overfitting of machine learning module 310 to the training data. Example generalization techniques include dropout techniques; weight decay techniques; batch normalization; early stopping; subset selection; stepwise selection; etc.

In some examples, machine learning module 310 described herein can include or otherwise be impacted by a number of hyperparameters, such as, for example, learning rate, number of layers, number of nodes in each layer, number of leaves in a tree, number of clusters; etc. Hyperparameters can affect model performance. Hyperparameters can be hand selected or can be automatically selected through application of techniques such as, for example, grid search; black box optimization techniques (e.g., Bayesian optimization, random search, etc.); gradient-based optimization; etc. Example techniques and/or tools for performing automatic hyperparameter optimization include Hyperopt; Auto-WEKA; Spearmint; Metric Optimization Engine (MOE); etc.

In some examples, various techniques can be used to optimize and/or adapt the learning rate when the model is trained. Example techniques and/or tools for performing learning rate optimization or adaptation include Adagrad; Adaptive Moment Estimation (ADAM); Adadelta; RMSprop; etc.

In some examples, transfer learning techniques can be used to provide an initial model from which to begin training of machine learning module 310 described herein. In some examples, transfer learning involves reusing a model and its model parameters obtained while solving one problem and applying it to a different but related problem. Models trained on very large data sets may be retrained or fine-tuned on additional data. Often, all model designs and their parameters on a source model are copied except output layer(s). The output layers(s) are often called the head, and other layers are often called the base. The source parameters may be considered to contain the knowledge learned from the source dataset and this knowledge may also be applicable to a target dataset. Fine-tuning may include updating the head parameters with the body parameters being fixed or updated in a later step.

In some examples, machine learning module 310 may be trained in an offline fashion or an online fashion. In offline training (also known as batch learning), machine learning module 310 is trained on the entirety of a static set of training data. In online learning, machine learning module 310 is continuously trained (or re-trained) as new training data becomes available (e.g., while the model is used to perform inference).

In some examples, training process 340 may involve centralized training of machine learning module 310 (e.g., based on a centrally stored dataset). In other implementations, decentralized training techniques such as distributed training, federated learning, or the like can be used to train, update, or personalize machine learning module 310.

Machine learning module 310 described herein can be trained according to one or more of various different training types or techniques. For example, in some examples, machine learning module 310 can be trained by training process 340 using supervised learning, in which machine learning module 310 is trained on a training dataset that includes instances or examples that have labels. The labels can be manually applied by experts, generated through crowdsourcing, or provided by other techniques (e.g., by physics-based or complex mathematical models). In some examples, if the user has provided consent, the training examples can be provided by the user computing device. In some examples, this process can be referred to as personalizing the model.

In some examples, machine learning module 310 includes a language model that may be trained (e.g., pre-trained, fine-tuned, etc.) by training process 340. For example, training process 340 may pre-train a language model on a large and diverse corpus of text. As such, in some examples, training data 331 may include a dataset that covers a wide range of topics and domains to ensure machine learning module 310 learns diverse linguistic patterns and contextual relationships. Training process 340 may train a language model to optimize objective function 339. Objective function 339 may be or include a loss function, such as cross-entropy loss, that compares (e.g., determines a difference between) output data generated by the model from training data 331 and labels 337 (e.g., ground-truth labels) associated with training data 331. For example, objective function 339 for a language model may be to correctly predict the next word in a sequence of words or correctly fill in missing words as much as possible.

In some examples, training process 340 may use techniques such low-rank adaptation (LoRA) to train or fine-tune language models (LLMs) implemented by machine learning module 310. In general, LoRA may reduce the number of trainable parameters by freezing pre-trained weights of an LLM and injecting small, trainable low-rank matrices that adapt the model for specific tasks. LoRa may be useful when a model needs to be adapted to multiple tasks with limited task-specific data. That is, training process 340 may use LoRA for task-specific fine-tuning. In some examples, training process 340 may use techniques such as retrieval-augmented generation (RAG), which is a hybrid framework that combines information retrieval with text generation. RAG may be used to fine-tune a generative model implemented by machine learning module 310 by retrieving relevant information from an external database or dataset (e.g., a large and diverse corpus of text) and using that information to generate output that is more accurate and informative. RAG may be useful for generating more factually accurate and contextually relevant summaries and responses to questions.

In some examples, training process 340 may continuously or periodically train a language model included in machine learning module 310. In some examples, training process 340 may fine-tune a language model by using feedback in the training process. For example, UI component 202 of FIG. 2 may receive a user input via a computing device that selects feedback (e.g., thumbs up, thumbs down, etc.) relating to the generated application functionality and associated GUIs that are presented to the user on the computing device. In some examples, the feedback may indicate whether the generated application functionality and associated GUIs are accurate or inaccurate, correct or incorrect, high quality or low quality, etc. UI module 204 may receive this feedback and may send it to content search module 208. Content search module 208 may transmit the feedback to machine learning module 310 (specifically to training process 340), in which training process 340 uses the feedback for training. For example, training process 340 may convert the feedback into labeled data for supervised training. Additionally, or alternatively, training process 340 may fine-tune a language model by monitoring the relationship between the performance of the language model and user feedback, and iterate the fine-tuning process as necessary (e.g., to receive more positive user feedback and less negative user feedback). In this way, the techniques of this disclosure may establish a feedback loop that continuously improves the quality of output data 335 (e.g., an instructions file) of a language model.

FIG. 3B is a conceptual diagram illustrating an example trained machine learning module, in accordance with one or more techniques of this disclosure. In some examples, computing device 112 of FIG. 1 may store and implement machine learning module 310 locally (i.e., on-device). Thus, in some examples, machine learning module 310 can be stored at and/or implemented locally by an embedded device or a user computing device such as a mobile device. Output data obtained through local implementation of machine learning module 310 at the embedded device or the user computing device can be used to improve performance of the embedded device or the user computing device (e.g., an application implemented by the embedded device or the user computing device). Machine learning module 310 of FIG. 3B may be trained at a computing system, such as computing system 100 of FIG. 1, and then provided for storage and/or implementation at one or more computing devices, such as computing device 112 of FIG. 1. In some examples, machine learning module 310 executes locally at computing system 100 of FIG. 1. In some examples, computing system 100 may perform machine learning as a service.

As illustrated in FIG. 3B, in some examples, machine learning module 310 is trained (e.g., via training process 340 of FIG. 3A) to receive input data 333, which may be of one or more types and, in response, provide output data 335, which may be of one or more types. Thus, FIG. 3B illustrates machine learning module 310 performing inference, in which machine learning module 310 may use learned patterns to make predictions or decisions on new data, e.g., input data 333. Machine learning module 310 may include one or more machine-learned models trained by training process 340 of FIG. 3A.

Input data 333 may include one or more features that are associated with an instance or an example. In some examples, the one or more features associated with the instance or example can be organized into a feature vector. In some examples, output data 335 can include one or more predictions. Predictions can also be referred to as inferences. Thus, given features associated with a particular instance, machine learning module 310 can output a prediction for such instance based on the features.

Machine learning module 310 can be or include one or more of various different types of machine-learned models. In particular, in some examples, machine learning module 310 may perform NLP tasks. Machine learning module 310 may summarize, translate, or organize input data 333. Machine learning module 310 may use recurrent neural networks (RNNs) and/or transformer models (self-attention models). Example models may include, but are not limited to, GPT-3, BERT, Gemini (e.g., Gemini Ultra, Gemini Pro, Gemini Flash, Gemini Nano), Android AICore, and T5. In some examples, machine learning module 310 may perform classification, summarization, name generation, regression, clustering, anomaly detection, recommendation generation, and/or other tasks.

In some examples, machine learning module 310 can perform various types of classification based on input data 333. For example, machine learning module 310 can perform binary classification or multiclass classification. In binary classification, output data 335 can include a classification of input data 333 into one of two different classes. In multiclass classification, output data 335 can include a classification of input data 333 into one (or more) of more than two classes. The classifications can be single label or multi-label. Machine learning module 310 may perform discrete categorical classification in which input data 333 is simply classified into one or more classes or categories.

In some examples, machine learning module 310 can perform classification in which machine learning module 310 provides, for each of one or more classes, a numerical value descriptive of a degree to which it is believed that input data 333 should be classified into the corresponding class. In some instances, the numerical values provided by machine learning module 310 can be referred to as “confidence scores” that are indicative of a respective confidence associated with classification of the input into the respective class. In some examples, the confidence scores can be compared to one or more thresholds to render a discrete categorical prediction. In some examples, only a certain number of classes (e.g., one) with the relatively largest confidence scores can be selected to render a discrete categorical prediction.

Machine learning module 310 may output a probabilistic classification. For example, machine learning module 310 may predict, given a sample input, a probability distribution over a set of classes. Thus, rather than outputting only the most likely class to which the sample input should belong, machine learning module 310 can output, for each class, a probability that the sample input belongs to such class. In some examples, the probability distribution over all possible classes can sum to one. In some examples, a Softmax function, or other type of function or layer can be used to squash a set of real values respectively associated with the possible classes to a set of real values in the range (0, 1) that sum to one.

In some examples, the probabilities provided by the probability distribution can be compared to one or more thresholds to render a discrete categorical prediction. In some examples, only a certain number of classes (e.g., one) with the relatively largest predicted probability can be selected to render a discrete categorical prediction.

In cases in which machine learning module 310 performs classification, machine learning module 310 may be trained using supervised learning techniques. For example, machine learning module 310 may be trained on a training dataset that includes training examples labeled as belonging (or not belonging) to one or more classes.

In some examples, machine learning module 310 can perform regression to provide output data in the form of a continuous numeric value. The continuous numeric value can correspond to any number of different metrics or numeric representations, including, for example, currency values, scores, or other numeric representations. As examples, machine learning module 310 can perform linear regression, polynomial regression, or nonlinear regression. As examples, machine learning module 310 can perform simple regression or multiple regression. As described above, in some examples, a Softmax function or other function or layer can be used to squash a set of real values respectively associated with two or more possible classes to a set of real values in the range (0, 1) that sum to one.

Machine learning module 310 may perform various types of clustering. For example, machine learning module 310 can identify one or more previously defined clusters to which input data 333 most likely corresponds. Machine learning module 310 may identify one or more clusters within input data 333. That is, in instances in which input data 333 includes multiple objects, documents, or other entities, machine learning module 310 can sort the multiple entities included in input data 333 into a number of clusters. In some examples in which machine learning module 310 performs clustering, machine learning module 310 can be trained using unsupervised learning techniques.

Machine learning module 310 may perform anomaly detection or outlier detection. For example, machine learning module 310 can identify input data that does not conform to an expected pattern or other characteristic (e.g., as previously observed from previous input data). As examples, the anomaly detection can be used for fraud detection or system failure detection.

In some examples, machine learning module 310 can provide output data in the form of one or more recommendations. For example, machine learning module 310 can be included in a recommendation system or engine. As an example, given input data that describes previous outcomes for certain entities (e.g., a score, ranking, or rating indicative of an amount of success or enjoyment), machine learning module 310 can output a suggestion or recommendation of one or more additional entities that, based on the previous outcomes, are expected to have a desired outcome (e.g., elicit a score, ranking, or rating indicative of success or enjoyment). As one example, given input data descriptive of a context of a computing device, such as computing device 112 of FIG. 1, a recommendation system can output a suggestion or recommendation of an application that the user might enjoy or wish to download to computing device 112.

Machine learning module 310 may, in some cases, act as an agent within an environment. For example, machine learning module 310 can be trained using reinforcement learning, which will be discussed in further detail below.

In some examples, machine learning module 310 can be a parametric model while, in other implementations, machine learning module 310 can be a non-parametric model. In some examples, machine learning module 310 can be a linear model while, in other implementations, machine learning module 310 can be a non-linear model.

As described above, machine learning module 310 can be or include one or more of various different types of machine-learned models. Examples of such different types of machine-learned models are provided below for illustration. One or more of the example models described below can be used (e.g., combined) to provide output data 335 in response to input data 333. Additional models beyond the example models provided below can be used as well.

In some examples, machine learning module 310 can be or include one or more classifier models such as, for example, linear classification models; quadratic classification models; etc. Machine learning module 310 may be or include one or more regression models such as, for example, simple linear regression models; multiple linear regression models; logistic regression models; stepwise regression models; multivariate adaptive regression splines; locally estimated scatterplot smoothing models; etc.

In some examples, machine learning module 310 can be or include one or more decision tree-based models such as, for example, classification and/or regression trees; iterative dichotomiser 3 decision trees; C4.5 decision trees; chi-squared automatic interaction detection decision trees; decision stumps; conditional decision trees; etc.

Machine learning module 310 may be or include one or more kernel machines. In some examples, machine learning module 310 can be or include one or more support vector machines. Machine learning module 310 may be or include one or more instance-based learning models such as, for example, learning vector quantization models; self-organizing map models; locally weighted learning models; etc. In some examples, machine learning module 310 can be or include one or more nearest neighbor models such as, for example, k-nearest neighbor classifications models; k-nearest neighbors regression models; etc. Machine learning module 310 can be or include one or more Bayesian models such as, for example, naïve Bayes models; Gaussian naïve Bayes models; multinomial naïve Bayes models; averaged one-dependence estimators; Bayesian networks; Bayesian belief networks; hidden Markov models; etc.

In some examples, machine learning module 310 can be or include one or more artificial neural networks (also referred to simply as neural networks). A neural network can include a group of connected nodes, which also can be referred to as neurons or perceptrons. A neural network can be organized into one or more layers. Neural networks that include multiple layers can be referred to as “deep” networks. A deep network can include an input layer, an output layer, and one or more hidden layers positioned between the input layer and the output layer. The nodes of the neural network can be connected or non-fully connected.

Machine learning module 310 can be or include one or more feed forward neural networks. In feed forward networks, the connections between nodes do not form a cycle. For example, each connection can connect a node from an earlier layer to a node from a later layer.

In some instances, machine learning module 310 can be or include one or more recurrent neural networks. In some instances, at least some of the nodes of a recurrent neural network can form a cycle. Recurrent neural networks can be especially useful for processing input data that is sequential in nature. In particular, in some instances, a recurrent neural network can pass or retain information from a previous portion of input data 333 sequence to a subsequent portion of input data 333 sequence through the use of recurrent or directed cyclical node connections.

In some examples, sequential input data can include time-series data (e.g., sensor data versus time or imagery captured at different times). For example, a recurrent neural network can analyze sensor data versus time to detect or predict a swipe direction, to perform handwriting recognition, etc. Sequential input data may include words in a sentence (e.g., for natural language processing, speech detection or processing, etc.); notes in a musical composition; sequential actions taken by a user (e.g., to detect or predict sequential application usage); sequential object states; etc.

Example recurrent neural networks include long short-term (LSTM) recurrent neural networks; gated recurrent units; bi-direction recurrent neural networks; continuous time recurrent neural networks; neural history compressors; echo state networks; Elman networks; Jordan networks; recursive neural networks; Hopfield networks; fully recurrent networks; sequence-to-sequence configurations; etc.

In some examples, machine learning module 310 can be or include one or more convolutional neural networks. In some instances, a convolutional neural network can include one or more convolutional layers that perform convolutions over input data using learned filters.

Filters can also be referred to as kernels. Convolutional neural networks can be especially useful for vision problems such as when input data 333 includes imagery such as still images or video. However, convolutional neural networks can also be applied for natural language processing.

In some examples, machine learning module 310 can be or include one or more generative networks such as, for example, generative adversarial networks. Generative networks can be used to generate new data such as new images or other content.

Machine learning module 310 may be or include an autoencoder. In some instances, the aim of an autoencoder is to learn a representation (e.g., a lower-dimensional encoding) for a set of data, typically for the purpose of dimensionality reduction. For example, in some instances, an autoencoder can seek to encode input data 333 and then provide output data that reconstructs input data 333 from the encoding. Recently, the autoencoder concept has become more widely used for learning generative models of data. In some instances, the autoencoder can include additional losses beyond reconstructing input data 333.

Machine learning module 310 may be or include one or more other forms of artificial neural networks such as, for example, deep Boltzmann machines; deep belief networks; stacked autoencoders; etc. Any of the neural networks described herein can be combined (e.g., stacked) to form more complex networks.

One or more neural networks can be used to provide an embedding based on input data 333. For example, the embedding can be a representation of knowledge abstracted from input data 333 into one or more learned dimensions. In some instances, embeddings can be a useful source for identifying related entities. In some instances, embeddings can be extracted from the output of the network, while in other instances embeddings can be extracted from any hidden node or layer of the network (e.g., a close to final but not final layer of the network). Embeddings can be useful for performing auto suggest next video, product suggestion, entity or object recognition, etc. In some instances, embeddings can be useful inputs for downstream models. For example, embeddings can be useful to generalize input data (e.g., search queries) for a downstream model or processing system.

Machine learning module 310 may include one or more clustering models such as, for example, k-means clustering models; k-medians clustering models; expectation maximization models; hierarchical clustering models; etc.

In some examples, machine learning module 310 can perform one or more dimensionality reduction techniques such as, for example, principal component analysis; kernel principal component analysis; graph-based kernel principal component analysis; principal component regression; partial least squares regression; Sammon mapping; multidimensional scaling; projection pursuit; linear discriminant analysis; mixture discriminant analysis; quadratic discriminant analysis; generalized discriminant analysis; flexible discriminant analysis; autoencoding; etc.

In some examples, machine learning module 310 can perform or be subjected to one or more reinforcement learning techniques such as Markov decision processes; dynamic programming; Q functions or Q-learning; value function approaches; deep Q-networks; differentiable neural computers; asynchronous advantage actor-critics; deterministic policy gradient; etc.

In some examples, machine learning module 310 can be an autoregressive model. In some instances, an autoregressive model can specify that output data 335 depends linearly on its own previous values and on a stochastic term. In some instances, an autoregressive model can take the form of a stochastic difference equation. One example autoregressive model is WaveNet, which is a generative model for raw audio.

In some examples, machine learning module 310 can include or form part of a multiple model ensemble. As one example, bootstrap aggregating can be performed, which can also be referred to as “bagging.” In bootstrap aggregating, a training dataset is split into a number of subsets (e.g., through random sampling with replacement) and a plurality of models are respectively trained on the number of subsets. At inference time, respective outputs of the plurality of models can be combined (e.g., through averaging, voting, or other techniques) and used as the output of the ensemble.

One example ensemble is a random forest, which can also be referred to as a random decision forest. Random forests are an ensemble learning method for classification, regression, and other tasks. Random forests are generated by producing a plurality of decision trees at training time. In some instances, at inference time, the class that is the mode of the classes (classification) or the mean prediction (regression) of the individual trees can be used as the output of the forest. Random decision forests can correct for decision trees'tendency to overfit their training set.

Another example ensemble technique is stacking, which can, in some instances, be referred to as stacked generalization. Stacking includes training a combiner model to blend or otherwise combine the predictions of several other machine-learned models. Thus, a plurality of machine-learned models (e.g., of same or different type) can be trained based on training data. In addition, a combiner model can be trained to take the predictions from the other machine-learned models as inputs and, in response, produce a final inference or prediction. In some instances, a single-layer logistic regression model can be used as the combiner model.

Another example of an ensemble technique is boosting. Boosting can include incrementally building an ensemble by iteratively training weak models and then adding to a final strong model. For example, in some instances, each new model can be trained to emphasize the training examples that previous models misinterpreted (e.g., misclassified). For example, a weight associated with each of such misinterpreted examples can be increased. One common implementation of boosting is AdaBoost, which can also be referred to as Adaptive Boosting. Other example boosting techniques include LPBoost; TotalBoost; BrownBoost; xgboost; MadaBoost, LogitBoost, gradient boosting; etc. Furthermore, any of the models described above (e.g., regression models and artificial neural networks) can be combined to form an ensemble. As an example, an ensemble can include a top-level machine-learned model or a heuristic function to combine and/or weight the outputs of the models that form the ensemble.

In some examples, multiple machine-learned models (e.g., that form an ensemble can be linked and trained jointly (e.g., through backpropagation of errors sequentially through the model ensemble). However, in some examples, only a subset (e.g., one) of the jointly trained models is used for inference.

In some examples, machine learning module 310 can be used to preprocess input data 333 for subsequent input into another model. For example, machine learning module 310 can perform dimensionality reduction techniques and embeddings (e.g., matrix factorization, principal components analysis, singular value decomposition, word2vec/GLOVE, and/or related approaches); clustering; and even classification and regression for downstream consumption.

As discussed above, machine learning module 310 can be trained or otherwise configured to receive input data 333 and, in response, provide output data 335. Input data 333 can include different types, forms, or variations of input data. As examples, in various implementations, input data 333 can include features that describe the content (or portion of content) initially selected by the user, e.g., content of user-selected document or image, links pointing to the user selection, links within the user selection relating to other files available on device or cloud, metadata of user selection, etc. Additionally, with user permission, input data 333 includes the context of user usage, either obtained from the app itself or from other sources. Examples of usage context include breadth of share (sharing publicly, or with a large group, or privately, or a specific person), context of share, etc. When permitted by the user, additional input data can include the state of the device, e.g., the location of the device, the apps running on the device, etc.

In some examples, machine learning module 310 can receive and use input data 333 in its raw form. In some examples, the raw input data can be preprocessed. Thus, in addition or alternatively to the raw input data, machine learning module 310 can receive and use the preprocessed input data.

In some examples, preprocessing input data 333 can include extracting one or more additional features from the raw input data. For example, feature extraction techniques can be applied to input data 333 to generate one or more new, additional features. Example feature extraction techniques include edge detection; corner detection; blob detection; ridge detection; scale-invariant feature transform; motion detection; optical flow; Hough transform; etc.

In some examples, the extracted features can include or be derived from transformations of input data 333 into other domains and/or dimensions. As an example, the extracted features can include or be derived from transformations of input data 333 into the frequency domain. For example, wavelet transformations and/or fast Fourier transforms can be performed on input data 333 to generate additional features.

In some examples, the extracted features can include statistics calculated from input data 333 or certain portions or dimensions of input data 333. Example statistics include the mode, mean, maximum, minimum, or other metrics of input data 333 or portions thereof.

In some examples, as described above, input data 333 can be sequential in nature. In some instances, the sequential input data can be generated by sampling or otherwise segmenting a stream of input data. As one example, frames can be extracted from a video. In some examples, sequential data can be made non-sequential through summarization.

As another example preprocessing technique, portions of input data 333 can be imputed. For example, additional synthetic input data can be generated through interpolation and/or extrapolation.

As another example preprocessing technique, some or all of input data 333 can be scaled, standardized, normalized, generalized, and/or regularized. Example regularization techniques include ridge regression; least absolute shrinkage and selection operator (LASSO); elastic net; least-angle regression; cross-validation; L1 regularization; L2 regularization; etc. As one example, some or all of input data 333 can be normalized by subtracting the mean across a given dimension's feature values from each individual feature value and then dividing by the standard deviation or other metric.

As another example preprocessing technique, some or all or input data 333 can be quantized or discretized. In some cases, qualitative features or variables included in input data 333 can be converted to quantitative features or variables. For example, one hot encoding can be performed.

In some examples, dimensionality reduction techniques can be applied to input data 333 prior to input into machine learning module 310. Several examples of dimensionality reduction techniques are provided above, including, for example, principal component analysis; kernel principal component analysis; graph-based kernel principal component analysis; principal component regression; partial least squares regression; Sammon mapping; multidimensional scaling; projection pursuit; linear discriminant analysis; mixture discriminant analysis; quadratic discriminant analysis; generalized discriminant analysis; flexible discriminant analysis; autoencoding; etc.

In some examples, during training, input data 333 can be intentionally deformed in any number of ways to increase model robustness, generalization, or other qualities. Example techniques to deform input data 333 include adding noise; changing color, shade, or hue; magnification; segmentation; amplification; etc.

In response to receipt of input data 333, machine learning module 310 can provide output data 335. Output data 335 can include different types, forms, or variations of output data. As examples, in various implementations, output data 335 can include content, either stored locally on the user device or in the cloud, that is relevantly shareable along with the initial content selection.

As discussed above, in some examples, output data 335 can include various types of classification data (e.g., binary classification, multiclass classification, single label, multi-label, discrete classification, regressive classification, probabilistic classification, etc.) or can include various types of regressive data (e.g., linear regression, polynomial regression, nonlinear regression, simple regression, multiple regression, etc.). In other instances, output data 335 can include clustering data, anomaly detection data, recommendation data, or any of the other forms of output data discussed above.

In some examples, output data 335 can influence downstream processes or decision making. As one example, in some examples, output data 335 can be interpreted and/or acted upon by a rules-based regulator.

Any of the different types or forms of input data described herein can be combined with any of the different types or forms of machine-learned models described herein to provide any of the different types or forms of output data described herein.

The systems and methods of the present disclosure can be implemented by or otherwise executed on one or more computing devices. Example computing devices include user computing devices (e.g., laptops, desktops, and mobile computing devices such as tablets, smartphones, wearable computing devices, etc.); embedded computing devices (e.g., devices embedded within a vehicle, camera, image sensor, industrial machine, satellite, gaming console or controller, or home appliance such as a refrigerator, thermostat, energy meter, home energy manager, smart home assistant, etc.); server computing devices (e.g., database servers, parameter servers, file servers, mail servers, print servers, web servers, game servers, application servers, etc.); dedicated, specialized model processing or training devices; virtual computing devices; other computing devices or computing infrastructure; or combinations thereof. A computing system that implements machine learning module 310 or other aspects of the present disclosure may include a number of hardware components that enable the performance of the techniques described herein.

In some instances, output data 335 obtained through machine learning module 310 at a computing system or device can be used to improve other device tasks or can be used by other non-user devices to improve services performed by or for such other non-user devices. For example, output data 335 can improve other downstream processes performed by a server device for a computing device of a user or embedded computing device. In other instances, output data 335 obtained through implementation of machine learning module 310 at a computing system or device can be sent to and used by a user computing device, an embedded computing device, or some other client device. In some examples, computing system 200 of FIG. 2 may perform machine learning as a service.

In yet other implementations, different respective portions of machine learning module 310 can be stored at and/or implemented by some combination of a user computing device; an embedded computing device; a server computing device; etc. In other words, portions of machine learning module 310 may be distributed in whole or in part amongst a client device (e.g., computing device 112 of FIG. 1) and a computing system (e.g., computing system 100 of FIG. 1).

A computing device such as computing device 112 of FIG. 1 may perform graph processing techniques or other machine learning techniques using one or more machine learning platforms, frameworks, and/or libraries, such as, for example, TensorFlow, Caffe/Caffe2, Theano, Torch/PyTorch, MXnet, CNTK, etc.

In some examples, multiple instances of machine learning module 310 can be parallelized to provide increased processing throughput. For example, the multiple instances of machine learning module 310 can be parallelized on a single processing device or computing device or parallelized across multiple processing devices or computing devices.

A computing device that implements machine learning module 310 or other aspects of the present disclosure can include a number of hardware components that enable performance of the techniques described herein. For example, a computing device can include one or more memory devices that store some or all of machine learning module 310. For example, machine learning module 310 can be a structured numerical representation that is stored in memory. The one or more memory devices can also include instructions for implementing machine learning module 310 or performing other operations. Example memory devices include RAM, ROM, EEPROM, EPROM, flash memory devices, magnetic disks, etc., and combinations thereof.

A computing device can also include one or more processing devices that implement some or all of machine learning module 310 and/or perform other related operations. Example processing devices include one or more of: a central processing unit (CPU); a visual processing unit (VPU); a graphics processing unit (GPU); a tensor processing unit (TPU); a neural processing unit (NPU); a neural processing engine; a core of a CPU, VPU, GPU, TPU, NPU or other processing device; an application specific integrated circuit (ASIC); a field programmable gate array (FPGA); a co-processor; a controller; or combinations of the processing devices described above. Processing devices can be embedded within other hardware components such as, for example, an image sensor, accelerometer, etc.

Hardware components (e.g., memory devices and/or processing devices) can be spread across multiple physically distributed computing devices and/or virtually distributed computing systems.

In some examples, machine learning module 310 described herein can be included in different portions of computer-readable code on a computing device. In one example, machine learning module 310 can be included in a particular application or program and used (e.g., exclusively) by such a particular application or program. Thus, in one example, a computing device can include a number of applications and one or more of such applications can contain its own respective machine learning library and machine-learned model(s).

In another example, machine learning module 310 described herein can be included in an operating system of a computing device (e.g., in a central intelligence layer of an operating system) and can be called or otherwise used by one or more applications that interact with the operating system. In some examples, each application can communicate with the central intelligence layer (and model(s) stored therein) using an application programming interface (API) (e.g., a common, public API across all applications).

In some examples, the central intelligence layer can communicate with a central device data layer. The central device data layer can be a centralized repository of data for the computing device. The central device data layer can communicate with a number of other components of the computing device, such as, for example, one or more sensors, a context manager, a device state component, and/or additional components. In some examples, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination.

Databases and applications can be implemented on a single system or distributed across multiple systems. Distributed components can operate sequentially or in parallel.

In addition, the machine learning techniques described herein are readily interchangeable and combinable. Although certain example techniques have been described, many others exist and can be used in conjunction with aspects of the present disclosure.

Further to the descriptions above, a user may be provided with controls that enable the user to make an election as to both if and when systems, programs or features described herein may enable collection of user information (e.g., information about a user's social network, social actions or activities, profession, a user's preferences, or a user's current location), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

FIG. 3C is a conceptual diagram illustrating a machine learning module configured to find and analyze content based on input received while a user is in an active play mode, in accordance with one or more techniques of this disclosure. Machine learning module 310 of FIG. 3 may be similar if not substantially similar to machine learning module 210 of FIG. 2 and/or machine learning module 110 of FIG. 1. As shown in the example of FIG. 3C, machine learning module 310 may further include content finder module 351, scoring module 350, and content storage 344.

In general, machine learning module 310 may receive input data, e.g., the at least one input associated with content being presented in an active play mode, and may process, store, analyze, transform, etc. the input data. As such, in some examples, the input data may be preprocessed. Preprocessing techniques may include extracting one or more additional features from raw data. For example, feature extraction techniques may be applied to the input data to generate one or more new, additional features. In some examples, machine learning module 310 may generate, based on the input data, a prompt, and may perform, using content finder module 351, the search for the other content based on the prompt. In some examples, the prompt may be a natural language prompt. In some examples, the prompt may be or include still images, videos, frames, and/or other data associated with the content in the active play mode, such as the user's progress point, timestamps, other contextual information, etc.

An example prompt may be generated based on, for example, an indication of a request from a user, an indication of a determined request, an indication of a progress point in the content being presented in the active play mode, context information associated with the content being presented in the active play mode, and/or at least the portion of the content being presented in the active play mode. For example, machine learning module 310 may determine, based on an activity log of a user's gameplay, that the user is having difficulty in advancing past the current progress point. As such, machine learning module 310 may intelligently generate a request to search for other content (e.g., tutorial videos) associated with the user's current progress point on the user's behalf. In some examples, machine learning module 310 may receive context information associated with the content being presented in the active play mode, such as a title of the content, the user's current progress point (e.g., level), the user's current gameplay statistics, a current gameplay mode (e.g., “beginner,” “intermediate,” “expert,” “single player,” “dual player,” etc.), and/or any other information that may be relevant to the content being presented in the active play mode. In some examples, machine learning module 210 may analyze portions of the retrieved information to interpret and understand other portions of the retrieved information. As such, an example prompt may be a natural language prompt such as, “Search a video platform for X Game tutorial videos that help a beginner player advance past level 4.” The prompt may be provided to content finder module 351, in which content finder module 351 may then perform the search for the other content (e.g., tutorial videos) based on the prompt. As such, in general, content finder module 351 may include a retrieval-augmented generation (RAG) model, a search-augmented model, or any other machine learning model that excels at natural language processing (NLP) and information retrieval capabilities. In some examples, content finder module 351 may additionally or alternatively employ a language model, e.g., a large language model (LLM), a transformer-based language model, etc. that can process a prompt to understand its intent and extract relevant search queries.

In some examples, content finder module 351 may implement other machine-learned models that may be used in place of or in conjunction with a machine learning model that excels at natural language processing (NLP) and information retrieval capabilities. For example, in some examples, machine learning module 310 may receive, additionally or alternatively, at least a portion of the content in the active play mode (e.g., video clips, frames, etc. associated with the user's progress point) as input. In some examples, machine learning module 310 may extract metadata (title, description, tags, etc.). In some examples, machine learning module 310 may analyze content (e.g., video content, stills, images, frames, etc.) using computer vision (e.g., scenes, objects, faces) and/or audio processing (e.g., transcript). In some examples, machine learning module 310 may encode data into a feature vector using pre-trained models (e.g., CLIP for visual-text embeddings). Thus, in some examples, content finder module 351 may additionally or alternatively perform the search based on similarities between features of the content in the active play mode and features of other content. For example, content finder module 351 may perform the search (e.g., a reverse image search, etc.) using video and/or image content as a prompt to find a related video game tutorial. In some examples, the video and/or image content may be indicative of the user's current progress point, and/or may be provided as input along with information indicative of the user's progress point, other information associated with the content in the active play mode, etc.

For example, content finder module 351 may employ similarity search techniques, such as an embedding-based search (e.g., finding videos with similar feature embeddings using models like Sentence Transformers, FAISS, cosine similarity, etc.), content-based filtering (e.g., matching videos with similar tags, keywords, categories, etc.), collaborative filtering (e.g., incorporating user behavior data such as viewing history and likes to refine results), and the like.

In some examples, content finder module 351 may include a query generator, which may convert a prompt into concise and optimized search queries. Content finder module 351 may be integrated with one or more search engines, such as a live search engine, through APIs. That is, once content finder module 351 determines a search query (which may indicate features of the content in the active play mode), content finder module 351 may forward the search query to an API (e.g., API module 206 of FIG. 2) such that the API may send the search query to one or more search engines and retrieve search results.

In some examples, after retrieval of the search results, i.e., other content (which may include content such as tutorial videos), machine learning module 310 may receive the search results for further processing and/or filtering. In general, machine learning module 310 may store, at least temporarily, the search results, e.g., other content, in content storage 344. Content (e.g., images, text, videos, URLs, etc.) may be stored in content storage 344 for use by other modules of machine learning module 310. In some examples, content storage 344 may operate, at least in part, as a cache. In general, content storage 344 may be configured as a database, flat file, table, or other data structure. In some examples, content storage 344 is shared between various modules (e.g., between one or more modules of machine learning module 310 and/or other modules not shown in FIG. 3C). In some examples, content storage 344 may store input data pertaining to the content being presented in the active play mode, such as for machine learning module 310 to further compare the content with the search results.

For example, in some examples, machine learning module 310 may employ scoring module 350 to determine one or more similarity scores between the search results and at least the portion of the content being presented in the active play mode. In general, scoring module 350 may employ similarity scoring techniques to refine the search results, and/or determine a similarity score for each search result such that a level of representation for at least the portion of the content in the search results can be determined.

For example, in some examples, scoring module 350 may employ feature embedding comparisons, in which scoring module may convert the portion of the content (e.g., video) and candidate search results into feature embeddings using pre-trained or fine-tuned models), and then compare the embeddings using similarity metrics such as cosine similarity, Euclidean distance, dot product, etc. In some examples, scoring module 350 may employ multi-modal similarity scoring, in which scoring module 350 may combine data from multiple modalities (e.g., visual features, audio features, text features) and then use weighted aggregation to combine similarity scores across modalities. In some examples, scoring module 350 may employ temporal analysis, in which scoring module 350 may compare sequences of frames (e.g., spatial and temporal features) using models such as 3D CNNs and/or transformer-based models, and may use dynamic time warping (DTW) for comparing temporal patterns of video features. As such, in some examples, such as examples in which a user may wish to create content for underrepresented gameplay areas, machine learning module 310 may determine, based on the one or more similarity scores determined by scoring module 350, the level of representation for at least the portion of the content in the other content.

As an example, content finder module 351 may return, based on a natural language prompt such as “Search a video platform for X Game tutorial videos that help a beginner player advance past level 4,” five search results. Scoring module 350 may then compare each search result to at least the portion of the content using one or more similarity scoring techniques, such as those described above. In this particular example, scoring module 350 may determine similarity scores of 10%, 20%, 22%, 30%, and 75%. In some examples, to determine a level of representation (or “representation score”) of the portion of content in the other content (i.e., search results), machine learning module 310 may determine an average of the one or more similarity scores. That is, continuing the example, machine learning module 310 may determine the level of representation of the portion of content in the other content to be 31.4%. In general, machine learning module 310 may determine whether the level of representation satisfies a threshold level of representation, such as to determine whether the portion of content is an underrepresented area of gameplay. In some examples, the threshold level of representation may be 10%, 20%, 30%, 40%, 50%, 60%, 70%, 80%, or 90%. In some examples, the threshold level of representation may be predefined. In some examples, the threshold level of representation may be intelligently determined by machine learning module 310, e.g., based on search trends. For instance, if tutorials for a particular area of gameplay is more frequently searched by users, the threshold level of representation may be lowered, as machine learning module 310 may determine that content created for the particular area of gameplay may still receive a significant amount of traffic, views, clicks, likes, etc. Continuing the example above, if the threshold level of representation is 50%, machine learning module 310 may determine that the 31.4% level of representation does not satisfy the threshold level of representation. That is, machine learning module 310 may determine that portion of the content being presented in the active play mode is an underrepresented area of gameplay, and thus the user may benefit from creating content for that area of gameplay (e.g., the user's content may receive more traffic, views, clicks, likes, etc.). As such, responsive to determining the level of representation does not satisfy the threshold level of representation, the computing system may transition the active play mode to a content creation mode, in which the system may automatically create content for the underrepresented area of gameplay on the user's behalf.

In some examples, however, the input received by machine learning module 310 may indicate that a user would like to receive other content (e.g., a tutorial video) rather than create new content. As such, in some examples, scoring module 350 may be used to refine search results for the user, and may assign scores to determine an order in which one or more of the search results should be presented to the user. In some examples, scoring module 350 may assign scores to other content based on relevance, recency, or popularity. In some examples, one or more models employed by scoring module 350 may be trained using various feedback mechanisms. In some examples, scoring module 350 may assign scores to search results based on user preferences. For example, in some examples, scoring module 350 may train one or more models using user feedback or implicit signals (e.g., watch time, clicks, skips) to re-rank results over time. In some examples, scoring module 350 may use metadata (categories, tags, release dates) to apply additional filters to search results. In some examples, scoring module 350 may use contextual filtering (e.g., matching or scoring results based on user preferences, device type, etc.), collaborative filtering, cluster and diversity adjustments (e.g., using clustering algorithms to group similar results and ensure diversity in the final selection), maximal marginal relevance (MMR) (e.g., to balance relevance and diversity in search results), and/or other techniques to optimize and/or rank the content found on the user's behalf. Then, the computing system may transition the active play mode to a content finder mode, in which the computing system may generate instructions file 346 for displaying the content being presented in the active play mode concurrently with at least a portion of the other content. That is, at least a portion of a search result (e.g., at least a portion of a tutorial video) with a highest score may be displayed concurrently with the content being presented in the active play mode.

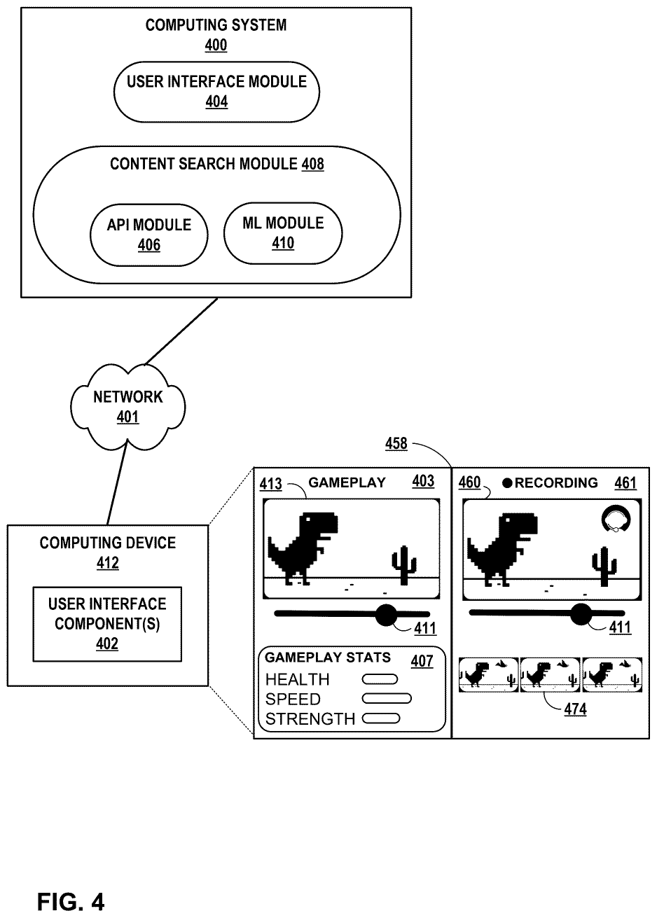

FIG. 4 is a conceptual diagram illustrating an example of a content creation mode, in accordance with one or more techniques of this disclosure. In the example of FIG. 4, a user may interact with computing device 412 that is in communication with computing system 400. Computing system 400, user interface module 404, content search module 408, API module 406, machine learning module 410, network 401, computing device 412, GUI 403, “Gameplay Stats” viewer 407, progress point 411, content 413, and UI components 402 may be similar if not substantially similar to computing system 100, user interface module 104, content search module 108, API module 106, machine learning module 110, network 101, computing device 112, GUI 103, “Gameplay Stats” viewer 107, progress point 111, content 113, and UI components 102 of FIG. 1, respectively. In some examples, some or all of the components and/or functionality attributed to computing system 400 may be implemented or performed by computing device 412.

As shown in the example of FIG. 4, UI components 402 may display creator mode GUI 458, which may be an example GUI for a content creation mode. That is, in the example of FIG. 4, responsive to receiving at least one input (e.g., an indication of a request from a user who wants to create content based on underrepresented gameplay areas and search trends), content search module 408 may perform, using machine learning module 410, a search for other content that is associated with at least a portion of content 413 being presented in the active play mode on GUI 403. For example, machine learning module 410 may search a database, a video platform, etc., for other content such as tutorial videos for progress point 411. Based on the search, machine learning module 410 may determine a level of representation for at least the portion of content 413 in the other content. Responsive to determining the level of representation does not satisfy a threshold level of representation, computing system 400 may transition the active play mode to a content creation mode.

In general, with explicit user consent, computing device 412 may continuously capture content 413 in an active play mode and/or computing system 400 may continuously receive the captured content. In general, with explicit user consent, computing device 412 and/or computing system 400 may store, at least temporarily (e.g., in a cache), the captured content. In some examples, content 413 in the active play mode may be captured regardless of whether computing system 400 receives input to perform a search.

In some examples, transitioning to the content creation mode may involve retrieving the captured content, in which at least a portion of this captured content may be stored (e.g., in a persistent data store or database) for content creation and/or later publishing. For example, transitioning to the content creation mode may involve retrieving the captured content (e.g., the last 10, 20, 30, 40, 50, 60, 70, 80, 90, 100, 120, etc. seconds of the user's screen) from a rolling buffer. In some other examples, when computing system 400 transitions the active play mode to the content creation mode, computing system 400 may cause computing device 412 to capture, e.g., record, content 413 being presented in the active play mode. For example, computing system 400 may cause computing device 412 to screen record GUI 403 that displays content 413 in the active play mode. Computing system 400 may receive the captured content and store the captured content in a memory.

In some examples, computing system 400 may generate instructions for displaying content 413 being presented in the active play mode concurrently with the captured content. That is, in some examples, the instructions may include instructions for displaying captured content 460, which may be captured content retrieved from a data store (e.g., a temporary data store).

In some examples, prior to storing the captured content in the memory, e.g., a persistent data store or database rather than a temporary data store or data cache, computing system 400 may generate instructions for displaying content 413 being presented in the active play mode concurrently with the captured content. That is, in the example of FIG. 4, computing system 400 may generate instructions for displaying content 413 being presented in the active play mode concurrently with captured content 460, which may, in some examples, be considered a live recording of content 413. As shown, creator mode GUI 458 may include at least two GUIs, such as GUI 461 that displays captured content 460 on a portion of the user's screen (e.g., GUI 461 may be the right half of creator mode GUI 458), and GUI 403 that displays content 413 on another portion of the user's screen (e.g., GUI 403 may be the left half of creator mode GUI 458). As such, while a user continues playing content 413 in the active play mode, the content created for the user (e.g., captured content 460) may be presented to them simultaneously in real-time or near real-time.

For example, in the example of FIG. 4, both captured content 460 and content 413 may display similar or substantially similar content, such as content associated with progress point 411. That is, captured content 460 may be considered to concurrently display a “mirror” of content 413. Thus, captured content 460 may be considered a live recording of content 413 that is initiated by content search module 408, and/or may be considered captured content retrieved from a temporary data store to use in content creation (e.g., capture content 460 may be moved to or otherwise stored in a persistent data store or database by computing system 400 and/or computing device 412 for future use or publishing by the user). In some examples, such as in the example of FIG. 4, GUI 461 may include a UI element that indicates GUI 461 is displaying content that is being or has been captured or recorded, e.g., GUI 461 may include a “RECORDING” text header and/or flashing circle to indicate captured content 460 is a recording of content 413. As further shown in the example of FIG. 4, in some examples, with explicit user permission, captured content 460 may include other content, UI elements, etc., such as a captured video of the user while the user is playing content 413. That is, in some examples, when the active play mode is transitioned to the content creation mode, UI components 402 may capture and/or receive additional input from a user. For example, with explicit user consent, a camera device may capture video of the user while the user plays content 413 in the active play mode, a microphone may capture audio of the user while the user plays content 413 in the active play mode, etc. As such, in some examples, captured content 460 may be considered “created content,” and may include a recording of at least a portion of content 413 as well as additional content that may improve the quality of the created content, such as the user's reactions, commentary, etc. Furthermore, in some examples, GUI 461 may include frames 474, which may display frames of captured content 460. For example, frames 474 may indicate various timestamps at which at least a portion of content 413 was recorded or captured. In some examples, after the recording has stopped, the user may interact with frames 474 to view, edit, and/or delete portions of captured content 460.

As such, by displaying GUI 461 including captured content 460, the user may be aware of the content that is being created on their behalf and may have more control over the final production of the created content. In general, however, creator mode GUI 458 may represent one example of a GUI for presenting content in a content creation mode. In some examples, creator mode GUI 458 may include additional elements not shown in FIG. 4, or may include elements that are different from those shown in FIG. 4. For example, in some examples, creator mode GUI 458 may include GUI 403, but may include the “RECORDING” text header instead of the “GAMEPLAY” text header, such as to indicate that content 413 is being captured or recorded. Furthermore, in some examples, once the recording is finished, creator mode GUI 458 may transition to include captured content 460 and/or frames 474, such that the user may view, edit, and/or delete portions of captured content 460.

In this way, content search module 408 may automatically generate or create content for a user on the user's behalf while the user is playing content 413 in the active play mode. That is, rather than a user having to manually research underrepresented gameplay areas and search trends to figure out which games, progress points, etc. to cater their created content to, content search module 408 may perform a search on the user's behalf while the user is playing content 413 in the active play mode. Responsive to content search module 408 determining a level of representation for at least the portion of content 413 does not satisfy a threshold level of representation, content search module 408 may transition the active play mode to the content creation mode, in which content search module 408 may generate instructions for displaying content 413 being presented in the active play mode concurrently with captured content 460. As such, the techniques described herein may provide users the ability to quickly and easily generate content, and thus may improve user experience with content searches and content creation.

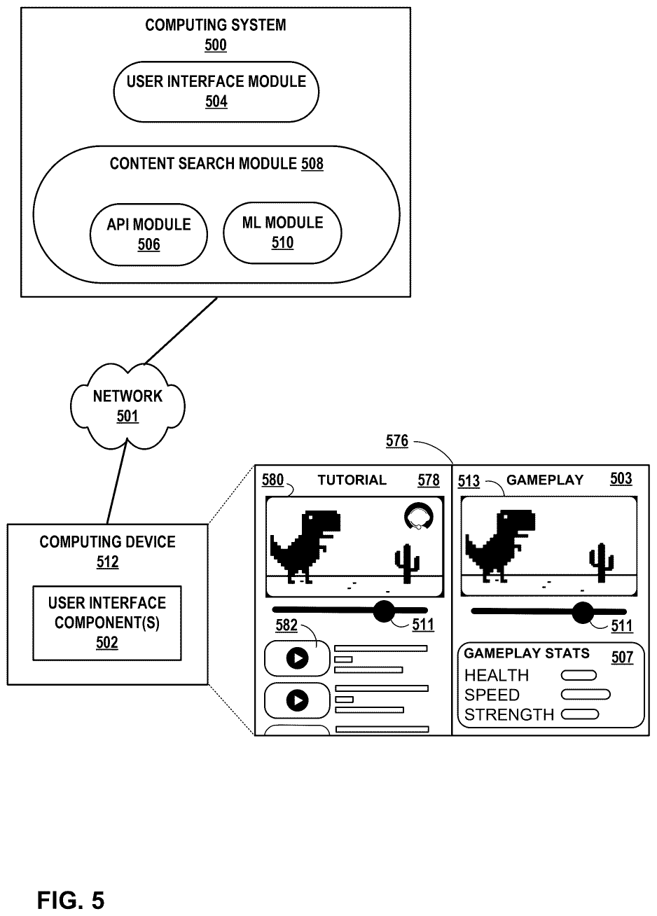

FIG. 5 is a conceptual diagram illustrating an example of a content finder mode, in accordance with one or more techniques of this disclosure. In the example of FIG. 5, a user may interact with computing device 512 that is in communication with computing system 500. Computing system 500, user interface module 504, content search module 508, API module 506, machine learning module 510, network 501, computing device 512, GUI 503, “Gameplay Stats” viewer 507, progress point 511, content 513, and UI components 502 may be similar if not substantially similar to computing system 100, user interface module 104, content search module 108, API module 106, machine learning module 110, network 101, computing device 112, GUI 103, “Gameplay Stats” viewer 107, progress point 111, content 113, and UI components 102 of FIG. 1, respectively. In some examples, some or all of the components and/or functionality attributed to computing system 500 may be implemented or performed by computing device 512.

As shown in the example of FIG. 5, UI components 502 may display content mode GUI 576, which may be an example GUI for a content finder mode that displays, e.g., other content such as a tutorial video. That is, in the example of FIG. 5, responsive to receiving at least one input (e.g., an indication of a request from a user who wants to find a tutorial video associated with progress point 511, or a request determined by computing system 500, such as a request intelligently generated by machine learning module 510 when machine learning module 510 determines an activity log indicates the user is having difficulty advancing past progress point 511), content search module 508 may determine to transition the active play mode to the content finder mode instead of the content creation mode. Then, computing system 500 may perform, using machine learning module 510, a search for other content that is associated with at least a portion of content 513 being presented in the active play mode on GUI 503. For example, machine learning module 510 may search a database, a video platform, etc., for other content such as tutorial videos for progress point 511. Then, based on the search, content search module 508 may generate instructions for displaying content 513 being presented in the active play mode concurrently with at least a portion of the other content. That is, as shown in the example of FIG. 5, when computing system 500 transitions the active play mode to the content finder mode, computing system 500 may generate instructions for displaying content 513 being presented in the active play mode concurrently with other content 580, which may be, for example, a tutorial video including content associated with progress point 511. As shown, content finder mode GUI 576 may include at least two GUIs, such as GUI 578 that displays other content 580 on a portion of the user's screen (e.g., GUI 578 may be the left half of content finder mode GUI 576), and GUI 503 that displays content 413 on another portion of the user's screen (e.g., GUI 503 may be the right half of content finder mode GUI 576). As such, while a user continues playing content 513 in the active play mode, the content found for the user (e.g., other content 580) may be presented to them simultaneously in real-time or near real-time.

For example, in the example of FIG. 5, both other content 580 and content 513 may display similar or substantially similar content, such as content associated with progress point 511. That is, content search module 508 may generate instructions for displaying other content 580 such that other content 580 is synced with content 513, e.g., at progress point 511. As such, the user may continue playing content 513 in the active play mode while simultaneously being presented a tutorial for advancing past their current progress point. In some examples, such as in the example of FIG. 5, GUI 578 may include a UI element that indicates GUI 578 is displaying other content such as a tutorial video, e.g., GUI 578 may include a “TUTORIAL” text header to indicate other content 580 is a tutorial video. As such, in general, other content 580 may be considered “found content,” and may include content that aids a user in advancing through their gameplay. Furthermore, in some examples, GUI 578 may include one or more additional content icons 582, which may represent other found content that is not currently being displayed by GUI 578, but may be displayed by GUI 578 upon a user interacting with (e.g., clicking on) an additional content icon 582. That is, in some examples, upon a user interacting with (e.g., clicking on) an additional content icon 582, GUI 578 may transition to display another found content item (e.g., another tutorial) instead of other content 580, in which the other found content item may also be synced with content 513 at progress point 511. In general, however, content finder mode GUI 576, which may be considered a “tutorial” mode, may represent one example of a GUI for presenting other content in a content finder mode. In some examples, content finder mode GUI 576 may include additional elements not shown in FIG. 5, or may include elements that are different from those shown in FIG. 5.

In this way, content search module 508 may automatically search for and find content for a user on the user's behalf while the user is playing content 513 in the active play mode. That is, rather than a user having to manually search for tutorial videos that can help the user advance in their gameplay, content search module 508 may perform a search on the user's behalf while the user is playing content 513 in the active play mode. Content search module 508 may transition the active play mode to the content finder mode, in which, based on the search results, content search module 508 may generate instructions for displaying content 513 being presented in the active play mode concurrently with other content 580. As such, the techniques described herein may provide users the ability to quickly and easily find other content (e.g., tutorial videos) that is related to the content they are currently streaming or playing, and thus may improve user experience with content searches.

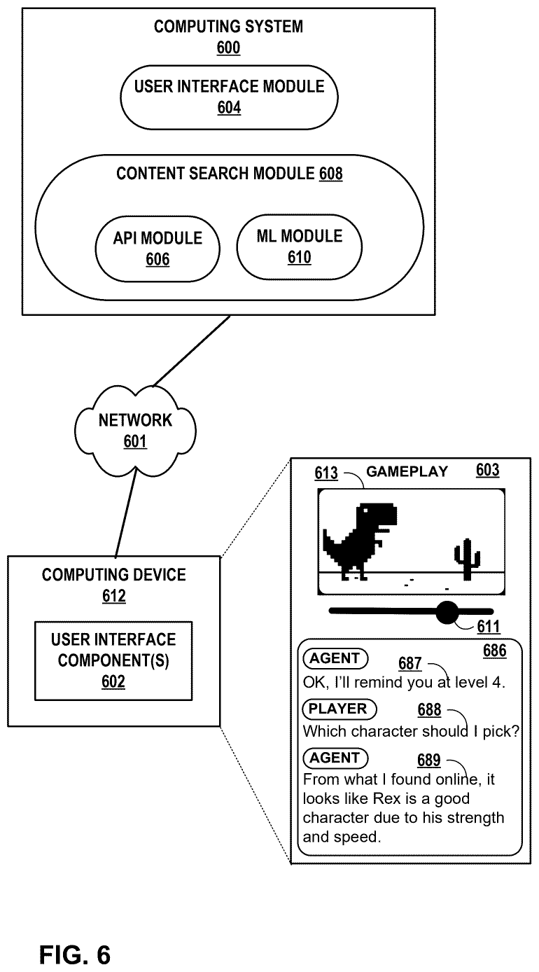

FIG. 6 is a conceptual diagram illustrating another example of an active play mode, in accordance with one or more techniques of this disclosure. In the example of FIG. 6, a user may interact with computing device 612 that is in communication with computing system 600. Computing system 600, user interface module 604, content search module 608, API module 606, machine learning module 610, network 601, computing device 612, GUI 603, progress point 611, content 613, and UI components 602 may be similar if not substantially similar to computing system 100, user interface module 104, content search module 108, API module 106, machine learning module 110, network 101, computing device 112, GUI 103, progress point 111, content 113, and UI components 102 of FIG. 1, respectively. In some examples, some or all of the components and/or functionality attributed to computing system 600 may be implemented or performed by computing device 612.

In some examples, the active play mode may be configured as a “companion agent mode.” That is, in some examples, a user may interact with an artificial intelligence (AI) agent or an autonomous intelligent system such as a “chatbot” that can simulate a conversation (e.g., a natural language conversation) with a user while the user is actively playing content 613 in the active play mode. Chatbots can use a variety of techniques to understand and respond to user questions or queries, such as machine learning techniques, natural language processing (NLP) techniques, automatic speech recognition (ASR) (e.g., to analyze speech patterns and provide voice-enabled responses), etc.

As shown in the example of FIG. 6, UI components 602 may display GUI 603, which may be another example of GUI 103 of FIG. 1 that represents a user's current screen while streaming or playing content, such as a video game. That is, in the example of FIG. 6, GUI 603 may be considered an active play mode user interface. As shown, GUI 603 may include interactive chat log 686, which may display conversations between a user (“PLAYER”) and an AI agent (“AGENT”).

As an example, a user may speak at least one natural language query, command, request, etc. associated with content 613 being presented in a first portion of an active play mode GUI 603 (e.g., a top portion of GUI 603). The at least one natural language query may be captured by UI components 602 (e.g., a microphone), and computing system 600 may receive an indication of the at least one natural language query. In some examples, computing system 600 may apply one or more speech-to-text techniques to the indication of the natural language query to generate text data indicative of the at least one natural language query. For example, computing system 600 may receive an indication of a natural language audio input such as “Which character should I pick?”, which computing system 600 may transcribe into text. Then, computing system 100 may output the text data indicative of the at least one natural language query to computing device 612, in which UI components 602 may display text data 688 indicative of the at least one natural language query in a second portion of the active play mode GUI 603, e.g., in interactive chat log 686. As shown, text data 688 may be text transcribed from the user's natural language query asking, “Which character should I pick?”

Content search module 608 may receive an indication of the at least one natural language query) and may apply machine learning module 610 to generate at least one natural language response for the at least one natural language query. For example, in some examples, the natural language response for the at least one natural language query may be generated based on stored data (e.g., a previous query from a user, such as “Remind me how to perform the quest on level 4”), context information associated with content 613 (e.g., UI layout information, elements currently being presented on the screen, title, user progress point, etc.), web search results (e.g., responsive to queries such as “What character do you recommend?”, “How do I do this?”, “What are the best characters, can you search a web forum?”, etc.), any other information and/or input described herein, etc. In some examples, content search module 608 may process other content, e.g., search results returned by a web search (such as tutorial videos, webpages associated with the video game, etc.), and may generate a brief summary (e.g., based on tutorial video transcripts, webpage content, etc.) that answers the user's query. For example, content search module 608 may perform, using machine learning module 610, a search for other content that is associated with at least a portion of content 613 being presented in the active play mode on GUI 603. For example, machine learning module 610 may search a database, a video platform, etc., for other content that indicates, for example, a character that the user should pick.

Computing system 600 may output, for display, natural language responses to user queries in interactive chat log 686 of active play mode GUI 603. For example, natural language response 687, which may be a response to a previous user query (not shown), may be displayed in interactive chat log 686 as text that reads, “OK, I'll remind you at level 4.” As further shown in the example of FIG. 6, responsive to receiving an indication of a natural language audio input such as “Which character should I pick?”, computing system 600 may output, for display, at least one natural language response 689 in interactive chat log 686 of active play mode GUI 603. In the example of FIG. 6, natural language response 689 may be text data indicative of the natural language response. For instance, as shown, natural language response 689 may be displayed in interactive chat log 686 as text that reads, “From what I found online, it looks like Rex is a good character due to his strength and speed.” In some examples, additionally or alternatively, natural language response 689 may be audio data indicative of the natural language response. That is, in some examples, while text data indicative of natural language response 686 is being displayed in interactive chat log 686, UI components 602 (e.g., a speaker) may play aloud audio data indicative of the natural language response, e.g., text data indicative of natural language response 686 may be read aloud to the user.

As such, in general, computing system 600 may be considered to be an “AI assistant” that can receive and respond to user queries in natural language conversation. In this way, users may play content while simultaneously interacting with an AI assistant that can intelligently find and/or generate information relevant to a user's gameplay and present user-friendly responses. Thus, the overall gaming experience for the user may be improved.

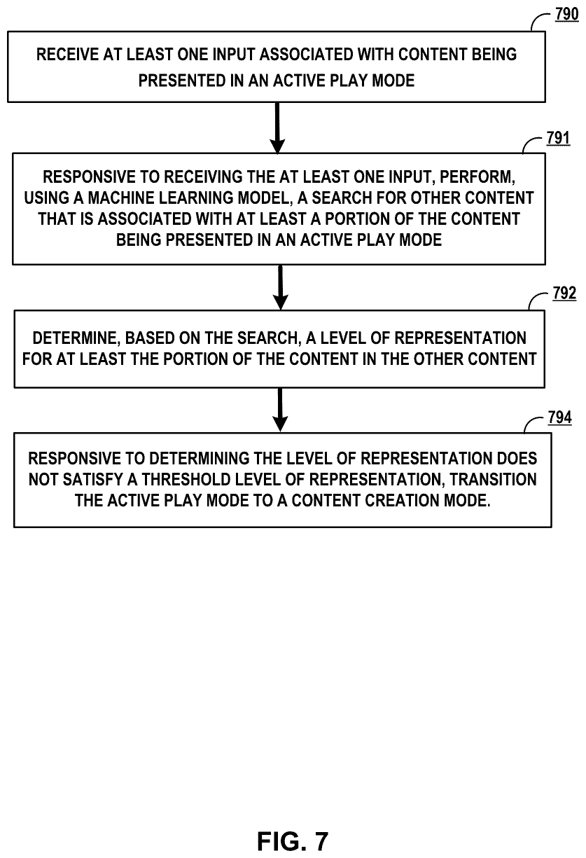

FIG. 7 is a flowchart illustrating an example operation for intelligently finding or generating content based on input received while a user is in an active play mode, in accordance with one or more techniques of this disclosure. For clarity, FIG. 7 may be described with respect to FIGS. 1-5.

Computing system 100 receives at least one input associated with content 113 being presented in an active play mode (790). In some examples, the at least one input associated with content 113 being presented in the active play mode includes one or more of an indication of a request from a user, an indication of a determined request, an indication of progress point 111 in content 113 being presented in the active play mode, context information associated with content 113 being presented in the active play mode, and at least the portion of content 113 being presented in the active play mode. In some examples, computing system 100 receives an activity log for at least the portion of content 113 being presented in the active play mode, and applies machine learning module 110 to the activity log to intelligently determine the determined request.

Responsive to receiving the at least one input, computing system 100 performs, using machine learning module 110, a search for other content that is associated with at least a portion of content 113 being presented in the active play mode (791). In some examples, machine learning module 100 includes a retrieval-augmented generation model. In some examples, to perform the search for the other content that is associated with at least the portion of content 113, computing system 100 generates, based on the at least one input, a prompt. In these examples, computing system 100 performs, using machine learning module 110, the search for the other content based on the prompt.

Computing system 100 determines, based on the search, a level of representation for at least the portion of content 113 in the other content (792). In some examples, the at least one input includes at least the portion of content 113 being presented in the active play mode, and to determine the level of representation for at least the portion of content in 113 the other content further, computing system 100 applies scoring module 350 to at least the portion of content 113 and at least a portion of the other content to determine one or more similarity scores. In these examples, computing system 100 determines, based on the one or more similarity scores, the level of representation for at least the portion of content 113 in the other content.

Responsive to determining the level of representation does not satisfy a threshold level of representation, computing system 100 transitions the active play mode to a content creation mode (794). In some examples, responsive to transitioning the active play mode to the content creation mode, computing system 100 retrieves captured content, and stores the captured content in a memory, such as instructions storage 222, which may be a persistent database or data store. In some examples though, prior to storing the captured content in the memory, computing system 100 generates instructions for displaying content 113 being presented in the active play mode concurrently with captured content 580.

In some examples, the at least one input includes one or more of the indication of the request from the user and the indication of the determined request. In some examples, responsive to receiving the at least one input, computing system 100 determines whether to transition the active play mode to a content finder mode instead of the content creation mode. Responsive to determining to transition the active play mode to a content finder mode instead of the content creation mode, computing system 100 performs, using machine learning module 110, the search for the other content that is associated with at least the portion of content 113. In these examples, computing system 100 transitions the active play mode to the content finder mode. In some examples, when transitioning the active play mode to the content finder mode, computing system 100 generates, based on the search, instructions for displaying content 113 being presented in the active play mode concurrently with at least a portion of other content 580.

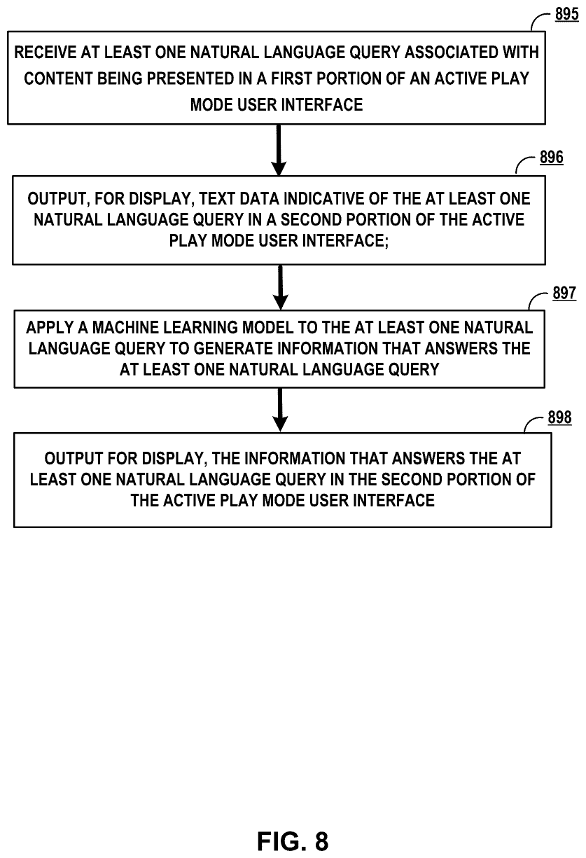

FIG. 8 is a flowchart illustrating an example operation for displaying generated output based on input received while a user is in an active play mode, in accordance with one or more techniques of this disclosure. For clarity, FIG. 8 may be described with respect to FIG. 6.

Computing system 600 receives at least one natural language query associated with content 613 being presented in a first portion of an active play mode GUI 603 (895). Computing system 600 outputs, for display, text data 688 indicative of the at least one natural language query in interactive chat log 686 of active play mode GUI 603 (896). Computing system 600 applies machine learning module 610 to the at least one natural language query to generate at least one natural language response for the at least one natural language query (897). Computing system 600 outputs, for display, the at least one natural language response in interactive chat log 686 of active play mode GUI 603 (898).

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. A computer program product may include a computer-readable medium.

By way of example, and not limitation, such computer-readable storage media may comprise RAM, ROM, EEPROM, CD-ROM or other optical disk storage, magnetic disk storage, or other magnetic storage devices, flash memory, or any other storage medium that may be used to store desired program code in the form of instructions or data structures and that may be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, various units may be combined in a hardware unit or provided by a collection of intraoperative hardware units, including one or more processors, in conjunction with suitable software and/or firmware.

It is to be recognized that, depending on the example, certain acts or events of any of the techniques described herein may be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In some examples, a computer-readable storage medium comprises a non-transitory medium. The term “non-transitory” indicates that the storage medium is not embodied in a carrier wave or a propagated signal. In certain examples, a non-transitory storage medium may store data that can, over time, change (e.g., in RAM or cache).

This disclosure includes the following examples:

Example 1: A method includes receiving, by a computing system, at least one input associated with content being presented in an active play mode; responsive to receiving the at least one input, performing, by the computing system, and using a machine learning model, a search for other content that is associated with at least a portion of the content being presented in the active play mode; determining, by the computing system and based on the search, a level of representation for at least the portion of the content in the other content; and responsive to determining the level of representation does not satisfy a threshold level of representation, transitioning, by the computing system, the active play mode to a content creation mode.

Example 2: The method of example 1, wherein the at least one input associated with the content being presented in the active play mode includes one or more of: an indication of a request from a user, an indication of a determined request, an indication of a progress point in the content being presented in the active play mode, context information associated with the content being presented in the active play mode, and at least the portion of the content being presented in the active play mode.

Example 3: The method of example 2, wherein the at least one input includes at least the portion of the content being presented in the active play mode, and wherein determining the level of representation for at least the portion of the content in the other content further comprises: applying, by the computing system, the machine learning model to at least the portion of the content and at least a portion of the other content to determine one or more similarity scores; and determining, by the computing system and based on the one or more similarity scores, the level of representation for at least the portion of the content in the other content.

Example 4: The method of any of examples 2 and 3, the method further includes receiving, by the computing system, an activity log for at least the portion of the content being presented in the active play mode; and applying, by the computing system, the machine learning model to the activity log to intelligently determine the determined request.

Example 5: The method of example 4, wherein the at least one input includes one or more of the indication of the request from the user and the indication of the determined request, the method further includes responsive to receiving the at least one input, determining, by the computing system, whether to transition the active play mode to a content finder mode instead of the content creation mode; responsive to determining to transition the active play mode to the content finder mode instead of the content creation mode, performing, by the computing system, and using the machine learning model, the search for the other content that is associated with at least the portion of the content; and transitioning, by the computing system, the active play mode to the content finder mode.

Example 6: The method of example 5, wherein transitioning the active play mode to the content finder mode further comprises: generating, by the computing system, and based on the search, instructions for displaying the content being presented in the active play mode concurrently with at least a portion of the other content.

Example 7: The method of any of examples 1 through 6, wherein performing the search for the other content that is associated with at least the portion of the content further comprises: generating, by the computing system and based on the at least one input, a prompt; and performing, by the computing system and using the machine learning model, the search for the other content based on the prompt.

Example 8: The method of any of examples 1 through 7, further includes responsive to transitioning the active play mode to the content creation mode, retrieving, by the computing system, captured content; and storing, by the computing system, the captured content in a memory.

Example 9: The method of example 8, further includes prior to storing the captured content in the memory, generating, by the computing system, instructions for displaying the content being presented in the active play mode concurrently with the captured content.

Example 10: The method of any of examples 1 through 9, wherein the machine learning model includes a retrieval-augmented generation model.

Example 11: A computing system includes one or more processors; and one or more storage devices that store instructions, that, when executed by the one or more processors, cause the one or more processors to: receive at least one input associated with content being presented in an active play mode; responsive to receiving the at least one input, perform, using a machine learning model, a search for other content that is associated with at least a portion of the content being presented in the active play mode; determine, based on the search, a level of representation for at least the portion of the content in the other content; and responsive to determining the level of representation does not satisfy a threshold level of representation, transition the active play mode to a content creation mode.

Example 12: The computing system of example 11, wherein the at least one input associated with the content being presented in the active play mode includes one or more of: an indication of a request from a user, an indication of a determined request, an indication of a progress point in the content being presented in the active play mode, context information associated with the content being presented in the active play mode, and at least the portion of the content being presented in the active play mode.

Example 13: The computing system of example 12, wherein the at least one input includes at least the portion of the content being presented in the active play mode, and wherein to determine the level of representation for at least the portion of the content in the other content, the instructions further cause the one or more processors to: apply the machine learning model to at least the portion of the content and at least a portion of the other content to determine one or more similarity scores; and determine, based on the one or more similarity scores, the level of representation for at least the portion of the content in the other content.

Example 14: The computing system of any of examples 12 and 13, wherein the instructions further cause the one or more processors to: receive an activity log for at least the portion of the content being presented in the active play mode; and apply the machine learning model to the activity log to intelligently determine the determined request.

Example 15: The computing system of example 14, wherein the at least one input includes one or more of the indication of the request from the user and the indication of the determined request, wherein the instructions further cause the one or more processors to: responsive to receiving the at least one input, determine whether to transition the active play mode to a content finder mode instead of the content creation mode; responsive to determining to transition the active play mode to the content finder mode instead of the content creation mode, perform, using the machine learning model, the search for the other content that is associated with at least the portion of the content; and transition the active play mode to the content finder mode.

Example 16: The computing system of example 15, wherein to transition the active play mode to the content finder mode, the instructions further cause the one or more processors to: generate, based on the search, instructions for displaying the content being presented in the active play mode concurrently with at least a portion of the other content.

Example 17: The computing system of any of examples 11 through 16, wherein to perform the search for the other content that is associated with at least the portion of the content, the instructions further cause the one or more processors to: generate, based on the at least one input, a prompt; and perform, using the machine learning model, the search for the other content based on the prompt.

Example 18: The computing system of any of examples 11 through 17, wherein the instructions further cause the one or more processors to: responsive to transitioning the active play mode to the content creation mode, retrieve captured content; and store the captured content in a memory.

Example 19: The computing system of example 18, wherein the instructions further cause the one or more processors to: prior to storing the captured content in the memory, generate instructions for displaying the content being presented in the active play mode concurrently with the captured content.

Example 20: The computing system of any of examples 11 through 19, wherein the machine learning model includes a retrieval-augmented generation model.

Example 21: A non-transitory computer-readable storage medium encoded with instructions that, when executed by one or more processors, cause one or more processors to: receive at least one input associated with content being presented in an active play mode; responsive to receiving the at least one input, perform, using a machine learning model, a search for other content that is associated with at least a portion of the content being presented in the active play mode; determine, based on the search, a level of representation for at least the portion of the content in the other content; and responsive to determining the level of representation does not satisfy a threshold level of representation, transition the active play mode to a content creation mode.

Example 22: The non-transitory computer-readable storage medium of example 21, wherein the at least one input associated with the content being presented in the active play mode includes one or more of: an indication of a request from a user, an indication of a determined request, an indication of a progress point in the content being presented in the active play mode, context information associated with the content being presented in the active play mode, and at least the portion of the content being presented in the active play mode.

Example 23: The non-transitory computer-readable storage medium of example 22, wherein the at least one input includes at least the portion of the content being presented in the active play mode, and wherein to determine the level of representation for at least the portion of the content in the other content, the instructions further cause the one or more processors to: apply the machine learning model to at least the portion of the content and at least a portion of the other content to determine one or more similarity scores; and determine, based on the one or more similarity scores, the level of representation for at least the portion of the content in the other content.

Example 24: The non-transitory computer-readable storage medium of any of examples 22 and 23, wherein the instructions further cause the one or more processors to: receive an activity log for at least the portion of the content being presented in the active play mode; and apply the machine learning model to the activity log to intelligently determine the determined request.

Example 25: The non-transitory computer-readable storage medium of example 24, wherein the at least one input includes one or more of the indication of the request from the user and the indication of the determined request, wherein the instructions further cause the one or more processors to: responsive to receiving the at least one input, determine whether to transition the active play mode to a content finder mode instead of the content creation mode; responsive to determining to transition the active play mode to the content finder mode instead of the content creation mode, perform, using the machine learning model, the search for the other content that is associated with at least the portion of the content; and transition the active play mode to the content finder mode.

Example 26: The non-transitory computer-readable storage medium of example 25, wherein to transition the active play mode to the content finder mode, the instructions further cause the one or more processors to: generate, based on the search, instructions for displaying the content being presented in the active play mode concurrently with at least a portion of the other content.

Example 27: The non-transitory computer-readable storage medium of any of examples 21 through 26, wherein to perform the search for the other content that is associated with at least the portion of the content, the instructions further cause the one or more processors to: generate, based on the at least one input, a prompt; and perform, using the machine learning model, the search for the other content based on the prompt.

Example 28: The non-transitory computer-readable storage medium of any of examples 21 through 27, wherein the instructions further cause the one or more processors to: responsive to transitioning the active play mode to the content creation mode, retrieve captured content; and store the captured content in a memory.

Example 29: The non-transitory computer-readable storage medium of example 28, wherein the instructions further cause the one or more processors to: prior to storing the captured content in the memory, generate instructions for displaying the content being presented in the active play mode concurrently with the captured content.

Example 30: The non-transitory computer-readable storage medium of any of examples 21 through 29, wherein the machine learning model includes a retrieval-augmented generation model.

Example 31: A computer program product for intelligently finding content, the computer program product comprising one or more instructions that, when executed by at least one processor, cause the at least one processor to: receive at least one input associated with content being presented in an active play mode; responsive to receiving the at least one input, perform, using a machine learning model, a search for other content that is associated with at least a portion of the content being presented in the active play mode; determine, based on the search, a level of representation for at least the portion of the content in the other content; and responsive to determining the level of representation does not satisfy a threshold level of representation, transition the active play mode to a content creation mode.

Example 32: The computer program product of example 31, wherein the at least one input associated with the content being presented in the active play mode includes one or more of: an indication of a request from a user, an indication of a determined request, an indication of a progress point in the content being presented in the active play mode, context information associated with the content being presented in the active play mode, and at least the portion of the content being presented in the active play mode.

Example 33: The computer program product of example 32, wherein the at least one input includes at least the portion of the content being presented in the active play mode, and wherein to determine the level of representation for at least the portion of the content in the other content, the instructions further cause the one or more processors to: apply the machine learning model to at least the portion of the content and at least a portion of the other content to determine one or more similarity scores; and determine, based on the one or more similarity scores, the level of representation for at least the portion of the content in the other content.

Example 34: The computer program product of any of examples 32 and 33, wherein the instructions further cause the one or more processors to: receive an activity log for at least the portion of the content being presented in the active play mode; and apply the machine learning model to the activity log to intelligently determine the determined request.

Example 35: The computer program product of example 34, wherein the at least one input includes one or more of the indication of the request from the user and the indication of the determined request, wherein the instructions further cause the one or more processors to: responsive to receiving the at least one input, determine whether to transition the active play mode to a content finder mode instead of the content creation mode; responsive to determining to transition the active play mode to the content finder mode instead of the content creation mode, perform, using the machine learning model, the search for the other content that is associated with at least the portion of the content; and transition the active play mode to the content finder mode.

Example 36: The computer program product of example 35, wherein to transition the active play mode to the content finder mode, the instructions further cause the one or more processors to: generate, based on the search, instructions for displaying the content being presented in the active play mode concurrently with at least a portion of the other content.

Example 37: The computer program product of any of examples 31 through 36, wherein to perform the search for the other content that is associated with at least the portion of the content, the instructions further cause the one or more processors to: generate, based on the at least one input, a prompt; and perform, using the machine learning model, the search for the other content based on the prompt.

Example 38: The computer program product of any of examples 31 through 37, wherein the instructions further cause the one or more processors to: responsive to transitioning the active play mode to the content creation mode, retrieve captured content; and store the captured content in a memory.

Example 39: The computer program product of example 38, wherein the instructions further cause the one or more processors to: prior to storing the captured content in the memory, generate instructions for displaying the content being presented in the active play mode concurrently with the captured content.

Example 40: The computer program product of any of examples 31 through 39, wherein the machine learning model includes a retrieval-augmented generation model.

Example 41: A computing device comprising: a memory that stores instructions; and one or more processors that execute the instructions to perform the method of any of examples 1-10.

Example 42: An apparatus comprising: means for performing the method of any of examples 1-10.

Example 43: A method comprising: receiving, by a computing system, at least one natural language query associated with content being presented in a first portion of an active play mode user interface; outputting, by the computing system, and for display, text data indicative of the at least one natural language query in a second portion of the active play mode user interface; applying, by the computing system, a machine learning model to the at least one natural language query to generate at least one natural language response for the at least one natural language query; and outputting, by the computing system, and for display, the at least one natural language response in the second portion of the active play mode user interface.

Various embodiments have been described. These and other embodiments are within the scope of the following claims.

What is claimed is:

1. A method comprising:
receiving, by a computing system, at least one input associated with content being presented in an active play mode;
responsive to receiving the at least one input, performing, by the computing system, and using a machine learning model, a search for other content that is associated with at least a portion of the content being presented in the active play mode;
determining, by the computing system and based on the search, a level of representation for at least the portion of the content in the other content; and
responsive to determining the level of representation does not satisfy a threshold level of representation, transitioning, by the computing system, the active play mode to a content creation mode.

2. The method of claim 1, wherein the at least one input associated with the content being presented in the active play mode includes one or more of:
an indication of a request from a user,
an indication of a determined request,
an indication of a progress point in the content being presented in the active play mode,
context information associated with the content being presented in the active play mode, and
at least the portion of the content being presented in the active play mode.

3. The method of claim 2, wherein the at least one input includes at least the portion of the content being presented in the active play mode, and wherein determining the level of representation for at least the portion of the content in the other content further comprises:
applying, by the computing system, the machine learning model to at least the portion of the content and at least a portion of the other content to determine one or more similarity scores; and
determining, by the computing system and based on the one or more similarity scores, the level of representation for at least the portion of the content in the other content.

4. The method of claim 2, the method further comprising:
receiving, by the computing system, an activity log for at least the portion of the content being presented in the active play mode; and
applying, by the computing system, the machine learning model to the activity log to intelligently determine the determined request.

5. The method of claim 4, wherein the at least one input includes one or more of the indication of the request from the user and the indication of the determined request, the method further comprising:
responsive to receiving the at least one input, determining, by the computing system, whether to transition the active play mode to a content finder mode instead of the content creation mode;
responsive to determining to transition the active play mode to a content finder mode instead of the content creation mode, performing, by the computing system, and using the machine learning model, the search for the other content that is associated with at least the portion of the content; and
transitioning, by the computing system, the active play mode to the content finder mode.

6. The method of claim 5, wherein transitioning the active play mode to the content finder mode further comprises:
generating, by the computing system, and based on the search, instructions for displaying the content being presented in the active play mode concurrently with at least a portion of the other content.

7. The method of claim 1, wherein performing the search for the other content that is associated with at least the portion of the content further comprises:
generating, by the computing system and based on the at least one input, a prompt; and
performing, by the computing system and using the machine learning model, the search for the other content based on the prompt.

8. The method of claim 1, further comprising:
responsive to transitioning the active play mode to the content creation mode, retrieving, by the computing system, captured content; and
storing, by the computing system, the captured content in a memory.

9. The method of claim 8, further comprising:
prior to storing the captured content in the memory, generating, by the computing system, instructions for displaying the content being presented in the active play mode concurrently with the captured content.

10. A computing system comprising:
one or more processors; and
one or more storage devices that store instructions, that, when executed by the one or more processors, cause the one or more processors to:
receive at least one input associated with content being presented in an active play mode;
responsive to receiving the at least one input, perform, using a machine learning model, a search for other content that is associated with at least a portion of the content being presented in the active play mode;
determine, based on the search, a level of representation for at least the portion of the content in the other content; and
responsive to determining the level of representation does not satisfy a threshold level of representation, transition the active play mode to a content creation mode.

11. The computing system of claim 10, wherein the at least one input associated with the content being presented in the active play mode includes one or more of:
an indication of a request from a user,
an indication of a determined request,
an indication of a progress point in the content being presented in the active play mode,
context information associated with the content being presented in the active play mode, and
at least the portion of the content being presented in the active play mode.

12. The computing system of claim 11, wherein the at least one input includes at least the portion of the content being presented in the active play mode, and wherein to determine the level of representation for at least the portion of the content in the other content, the instructions further cause the one or more processors to:
apply the machine learning model to at least the portion of the content and at least a portion of the other content to determine one or more similarity scores; and
determine, based on the one or more similarity scores, the level of representation for at least the portion of the content in the other content.

13. The computing system of claim 11, wherein the instructions further cause the one or more processors to:
receive an activity log for at least the portion of the content being presented in the active play mode; and
apply the machine learning model to the activity log to intelligently determine the determined request.

14. The computing system of claim 13, wherein the at least one input includes one or more of the indication of the request from the user and the indication of the determined request, wherein the instructions further cause the one or more processors to:
responsive to receiving the at least one input, determine whether to transition the active play mode to a content finder mode instead of the content creation mode;
responsive to determining to transition the active play mode to the content finder mode instead of the content creation mode, perform, using the machine learning model, the search for the other content that is associated with at least the portion of the content; and
transition the active play mode to the content finder mode.

15. The computing system of claim 14, wherein to transition the active play mode to the content finder mode, the instructions further cause the one or more processors to:
generate, based on the search, instructions for displaying the content being presented in the active play mode concurrently with at least a portion of the other content.

16. The computing system of claim 10, wherein to perform the search for the other content that is associated with at least the portion of the content, the instructions further cause the one or more processors to:
generate, based on the at least one input, a prompt; and
perform, using the machine learning model, the search for the other content based on the prompt.

17. The computing system of claim 10, wherein the instructions further cause the one or more processors to:
responsive to transitioning the active play mode to the content creation mode, retrieve captured content; and
store the captured content in a memory.

18. The computing system of claim 17, wherein the instructions further cause the one or more processors to:
prior to storing the captured content in the memory, generate instructions for displaying the content being presented in the active play mode concurrently with the captured content.

19. A non-transitory computer-readable storage medium encoded with instructions that, when executed by one or more processors, cause one or more processors to:
receive at least one input associated with content being presented in an active play mode;
responsive to receiving the at least one input, perform, using a machine learning model, a search for other content that is associated with at least a portion of the content being presented in the active play mode;
determine, based on the search, a level of representation for at least the portion of the content in the other content; and
responsive to determining the level of representation does not satisfy a threshold level of representation, transition the active play mode to a content creation mode.

20. The non-transitory computer-readable storage medium of claim 19, wherein the at least one input associated with the content being presented in the active play mode includes one or more of:
an indication of a request from a user,
an indication of a determined request,
an indication of a progress point in the content being presented in the active play mode,
context information associated with the content being presented in the active play mode, and
at least the portion of the content being presented in the active play mode.
